(19) United States
(12) Patent Application Publication
(10) Pub. No.: US 2004/0108281 A1
(43) Pub. Date: Jun. 10, 2004

(54) Invertible filter centrifuge

(75) Inventors: Hans Gerteis, Bietigheim-Bissingen (DE); Gerd Mayer, Besigheim (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Heinkel Aktiengesellschaft, Bietigheim-Bissingen (DE)

(21) Appl. No.: 10/673,117

(22) Filed: Sep. 26, 2003

Related U.S. Application Data
(63) Continuation of application No. PCT/EP02/01773, filed on Feb. 20, 2002.

(30) Foreign Application Priority Data
Mar. 28, 2001 (DE) 101 15 381.3

(51) Int. Cl. C02F 1/38

(52) U.S. Cl. 210/781; 210/360.1; 210/369

(57) ABSTRACT

A new type of invertible filter centrifuge is proposed, where a more compact construction is obtained and where the solids component is discharged substantially independently of its moisture content. The new type of invertible filter centrifuge has no filter cloth and comprises a centrifuging drum mounted rotatably in a drum housing with a drum wall enclosing a stationary, dimensionally stable filtering medium, a shaft driving the drum in rotation, a cover sealingly closing the open end of the drum at the edge of the drum, a feed means for suspension to be filtered, with a filling pipe leading into the interior of the drum, and a drum base arranged in the interior of the drum, the drum base and filtering medium or wall of the drum being axially displaceable relative to each other in order to discharge the solid constituent mechanically from the drum.

This application is a continuation of international application No. PCT/EP02/01773 filed Feb. 20, 2002. The present disclosure relates to the subject matter disclosed in international application No. PCT/EP02/01773, which is incorporated herein by reference in its entirety and for all purposes.

### BACKGROUND OF THE INVENTION

Invertible filter centrifuges of conventional construction, such as are known e.g. from DE 27 10 624, comprise a centrifugal drum mounted rotatably in a drum housing, a shaft joined to a closed end of the drum and rotating the drum, a cover sealingly closing the open end of the drum, a feed means for suspension to be filtered, with a filling pipe leading into the interior of the drum, and finally a filter cloth which may be inserted in the drum, the cloth on the one hand being fixed to the open end of the drum at the edge of the drum and on the other hand being joined to a drum base adjacent the closed end wall of the filtering drum. In the centrifuging process suspension to be filtered is fed into the interior of the drum, with the separating filtrate passing through the filter cloth and the wall of the drum, and the solids component of the suspension being deposited as a filter cake on the filter cloth inside the drum. The filter cake can easily be discharged from the drum mechanically, by opening the drum and moving the drum base together with the filter cloth attached to it towards the open end of the drum. The drum base is slid out of the drum far enough for the filter cloth finally to be turned right inside out, and the turning inside-out movement carries the filter cake out and ejects it.

The conventional invertible filter centrifuge meets its limits where suspensions which attack the filter cloth have to be filtered, as the cloth is only durable within certain limits. The housing enclosing the drum also has to be large enough for the entire inverting movement to be carried out, i.e. so that the drum base can be moved out of the drum a distance equal to the axial length of the drum.

As an alternative to the invertible filter centrifuge described above centrifuging machines are known (cf. for example EP 0 454 045) where the drum has a conically widening wall made of a metallic filtering medium on which the filter cake is deposited directly. As there is no filter cloth here to detach the filter cake from the wall of the drum and carry it out, a pneumatic means is provided, which detaches the filter cake from the wall of the drum and, aided by the conicity of that wall, conveys it into an annular channel arranged around the edge of the open end of the drum.

A problem with this centrifuging machine is that it guarantees satisfactory ejection of the filter cake only if the cake is dried to a relatively high degree beforehand. However situations are often encountered where drying of the cake to a degree allowing simple pneumatic discharge is tedious and energy-consuming or is completely impossible owing to the properties of the material, so in these cases the centrifuge working with a filter cloth offers considerable advantages.

The centrifuging machine with the metallic filtering medium in the wall of the drum and with pneumatic discharge on the other hand has the advantage over the invertible filter centrifuge of being shorter, yet this advantage very rarely compensates for the disadvantage described above.

### SUMMARY OF THE INVENTION

The problem of the invention, starting with an invertible filter centrifuge, is to modify it, firstly so that a more compact construction is obtained, and secondly so that the solids component can be discharged substantially independently of its moisture content.

The problem is solved by an invertible filter centrifuge without a filter cloth, comprising a centrifuging drum mounted rotatably in a drum housing with a drum wall comprising a stationary, dimensionally stable filtering medium, a shaft driving the drum in rotation, a cover sealingly closing the open end of the drum at the edge of the drum, a feed means for suspension to be filtered, with a filling pipe leading into the interior of the drum, and a drum base arranged in the interior of the drum, the drum base and filtering medium or wall of the drum being axially displaceable relative to each other in order to discharge the solid constituent mechanically from the drum, and the drum base having a sealing element at its peripheral surface, which element lies sealingly against the cylindrical wall of the drum in a withdrawn position of the drum base, adjacent the closed end wall of the drum.

The invention thus relates to a new type of invertible filter centrifuge where the use of a filter cloth is avoided. A centrifuge of this type will hereinafter be referred to as a clothless invertible filter centrifuge. The drum base known from the conventional invertible filter centrifuge is retained and now takes on a new function. Instead of holding and guiding the filter cloth it is used for mechanically discharging the solids component or filter cake.

The clothless invertible filter centrifuge according to the invention, like the centrifuge with a filter cloth, makes a kind of reversing movement with the drum base in the mechanical discharge of the solids component, such as is known per se from the classic centrifuge fitted with a cloth. Since there is no filter cloth to be turned inside out and the centrifuge operates without a cloth, the reversing movement can be reduced to about half the distance, i.e. the distance travelled by the drum base is limited to less than half.

A considerably more compact, i.e. shorter construction can accordingly be obtained for the centrifuge, similar to that of the centrifuging machine discussed above with pneumatic discharge of the filter cake. But as the cake is still discharged mechanically the disadvantages of such machines do not apply.

As an alternative to having the base of the drum travel relative to the stationary wall of the drum, the drum wall may be moved relative to the drum base or both parts may be moved simultaneously relative to each other in an axial direction. All the following statements and explanations will be based on the first alternative, namely of the drum base being moved. However they apply equally to the two other alternatives for the relative movement of the drum base and drum wall.

Another result of avoiding the filter cloth, i.e. as well as having the drum base travelling a shorter distance, is that even aggressive suspensions at high temperature can be processed in the centrifuge.

To enable the filter cake to be discharged as far as possible without leaving residues, the drum base preferably has a diameter only slightly smaller than the inside diameter of the drum at its closed end wall.

When the drum base is extended to discharge the solids component slight residues may then possibly be left clinging to the wall of the drum. Should the solids component be very dry, it can be almost completely discharged owing to the mechanical reversing movement of the drum base.

If is preferable to use a filtering medium which is self-supporting and does not require any separate support to maintain its dimensional stability. The dimensional stability of the wall of the drum, or of the filtering medium forming at least large parts of the wall, is important as no deformation of the wall occurs particularly while the filter cake is being discharged; such deformation would cause undesirably large quantities of solid residues or filter cake residues to be left in the drum.

Self-supporting filter media are also advantageous as the available area of drum wall can be maximised, yet no deformation of the wall takes place even during the actual centrifuging process.

Filtering media suitable for the clothless centrifuge are metallic, ceramic or plastics media or media made from a mixture of those materials. For example multi-layer metallic mesh nets with the mesh width increasing towards the outside are suitable.

In a preferred clothless centrifuge according to the invention, discharge of the filter cake can be assisted by the action of a pneumatic means used to detach and discharge filter cake residues.

The above-mentioned pneumatic means for detaching and discharging filter cake residues is preferably a device which produces a gas flow or flows axially of the drum towards its open end.

The gas flows or flow may be aligned parallel with the axis or at a slight inclination to the wall of the drum, firstly so that there is a gas flow component to detach the filter cake residues, and secondly so that the detached residues are simultaneously conveyed towards the open end of the drum.

Alternatively or additionally a gas flow or flows from the pneumatic means may act, blowing onto the drum in a radial direction. Gas flows blowing onto the drum in a radial direction particularly facilitate detachment of filter cake residues from the filtering medium or the wall of the drum formed by the filtering media. In particular a combination of gas flows acting in an axial and a radial direction provide an excellent cleaning action for detaching and discharging the filter cake residues.

The pneumatic means may be arranged statically relative to the wall of the drum, and the action of the pneumatic means is then preferably generated starting from the closed end wall and continuing towards the open end section of the drum, so that the filter cake residues are successively carried away, beginning adjacent the closed end wall and continuing towards the open end of the drum.

Alternatively the pneumatic means and the wall of the drum may be movable relatively to each other in the axial direction of the drum. The relative movement of the pneumatic means and the wall of the drum produces the same effect as that previously described with the controllable nozzles.

Particularly preferred pneumatic means can produce a pulsating gas flow or flows, which are considerably more effective in detaching filter cake residues from the wall of the drum. The volume of air used with them can also be minimised.

In another preferred pneumatic means nozzle outlets are provided for the gas flow and can be rotated at a different speed from the wall of the drum, thereby obtaining completely uniform application of the gas flow or individual gas flows emerging from the nozzles to the wall of the drum and the filtering medium in all parts of the wall surface.

A particularly preferred pneumatic means has nozzle outlets for the gas flows inside the drum; these may preferably be incorporated in the drum base.

To allow very simple cleaning of the clothless centrifuge outlets may be provided inside the drum for rinsing the drum wall, i.e. especially the filtering medium located there, with a liquid cleaning agent, particularly a solvent.

To ensure the separation from the environment, particularly the environment of the machine, which invertible filter centrifuges are required to have for pharmaceutical applications, the drum base has a sealing member on its peripheral surface which is sealingly applied to the cylindrical wall of the drum when the drum base is in a withdrawn position adjacent the closed end of the drum. This prevents suspension from getting onto the back of the drum base.

When the filter cake is discharged from the drum of the clothless centrifuge according to the invention the cover first has to be removed from the free end of the drum. During the centrifuging process on the other hand the cover is applied sealingly to the free end of the drum and has to be rotated with it.

In a simple construction which allows for both these conditions the cover is rigidly connected to the drum base by spacers. Thus when the drum base is slid forwards at the beginning of the mechanical cleaning or mechanical discharge of filter cake the cover is opened with it, and the mechanically discharged filter cake can drop out of the open end of the drum.

In a more expensive construction the cover may be removed from the free end independently of the drum base, bringing the advantage that the distance travelled by the cover to open the drum can be made shorter than the distance travelled by the drum base in mechanically discharging the filter cake. A still more compact construction of the centrifuging machine is then possible.

The cover, as seen in the axial direction of the drum, may for example be arranged stationary, while the drum is drawn back a short distance at the beginning of the discharging step, to make an adequate space between the cover and the open end of the drum, through which the filter cake material can then pass out of the drum when the drum base is subsequently slid forwards.

A preferred clothless invertible centrifuge has a drum housing which widens out conically in the direction from the open end of the drum to its closed end wall. In this way liquid filtrate leaving the drum is drained from the open end of the drum, from which the solid filter cake material is mechanically discharged in the subsequent discharging step. Thus a space can be made three-dimensionally between the outlet for the filtrate on the one hand and the part of the filter housing chamber which receives the filter cake or filter cake material.

Again the wall of the drum may likewise be slightly conical, though conicity in the opposite direction is recommended here, namely with the wall of the drum widening towards the open end of the drum. This allows very narrow tolerances for the drum base relative to the closed end wall and avoids blockage of the drum base when it is moved out of the drum, even in cases where the filter cake bakes very easily.

There are various ways of putting the suspension to be filtered into the interior of the closed drum. It is proposed in EP 0 454 045 to guide the suspension into the drum through the drive shaft. In accordance with the invention it is preferable however to provide the cover of the drum with an opening and to construct the feed pipe as a filling pipe which passes through the cover and leads into the interior of the drum during the centrifuging process. The filling pipe may be guided freely through the opening, so that contact between the pipe and the opening is avoided even during the centrifuging operation.

In filter centrifuges it is sometimes desirable to apply a gas at an over pressure (e.g. hot vapour) to the drum in order to raise the hydraulic pressure arising in the field of centrifugal force, or to blow through the filter cake in order to dry it, or to subject it to a vapour wash. Alternatively it may be desirable to subject the drum to an under pressure.

To have this opportunity of subjecting the centrifuging chamber surrounded by the drum to over pressure or under pressure in order to assist the filtration process or the filter cake drying process, provision is made in a preferred clothless invertible filter centrifuge for the filling pipe to be connected to pressure or low pressure sources to vary the pressure in the drum, and to be sealed off from the cover by a combined rotating and sliding seal. The rotating seal seals the filling pipe relative to the rotating cover and the sliding seal seals the pipe relative to the axially displaceable cover.

It is further preferable for the filling pipe to be supported on the housing in a resilient holding device which allows wobbling movements of the pipe in combination with the rotating and sliding seal. This allows for the fact that imbalances occur more or less frequently during the centrifuging process, leading to eccentric movement of the drum and hence eccentric movement of the cover with its inlet for the filling pipe. In this preferred embodiment of the clothless invertible centrifuge precautions are taken to prevent this movement from causing damage to the filling pipe and its premature wear-out.

This arrangement has three effects. The filling pipe is used simultaneously as a feed pipe for high-pressure gas (vapour) or to create low pressure by pumping out, so that special feed pipes for this purpose can be dispensed with. The combined rotating and sliding seal between the filling pipe and the cover prevents the gas under pressure from escaping from the centrifuging chamber or gas (atmospheric air) from entering the chamber from the outside. The resilient supporting of the filling pipe on the housing compensates for wobbling motions of the drum caused by imbalance, so that complete sealing by the combined rotating and sliding seal is guaranteed when the centrifuge is operating. There is no adverse effect on the sliding movement of the cover relative to the filling pipe.

In this connection the filling pipe is preferably fixed to the housing by a flange and with a resilient member interposed, and a thicker section tapering at both sides may possibly be provided at the outlet end of the filling pipe, ensuring a particularly simple seal with adequate room for movement to follow the wobbling motions of the drum.

The special construction of the rotating and sliding bearing on the one hand and the provision of a thicker section tapering at both sides at the outlet end of the filling pipe on the other hand no only guarantees that the centrifuging operation is as wear-free as possible but it also ensures that when the cover is displaced during the filter cake discharging phase the sealing interaction of the thicker section and the rotating and sliding seal is stopped, so that during the discharge phase the opening in the cover now surrounds the filling pipe with a spacing all round, and hence any strain on the rotating and sliding seal is completely avoided during that phase.

As an alternative to the possibility of operating the volume enclosed by the drum in pressure or low pressure conditions by means of the filling pipe, the side of the drum remote from the filling pipe may be connected by a pipe to a pressure or low pressure source. Supplying of pressurised gas or formation of a vacuum by the filling pipe is then separated from its function of feeding in suspension.

In this connection the feed aperture in the cover may preferably be capable of being sealed off from the filling pipe by a sealing member which rotates together with the drum and is uncoupled from the filling pipe so as to avoid frictional engagement.

Another alternative is to arrange the drum on a hollow shaft and mount a sealing member displaceably in that shaft, in such a way that it can close the feed aperture sealingly from inside the drum.

In a filling pipe arrangement extending through the cover it is further preferred that the filling pipe should be mounted rotatably about its longitudinal axis and able to be set in rotation about that axis together with the drum. A rotating/sliding seal in the aperture in the cover, which causes abrasion and thus the occurrence of contamination, can then be avoided.

The rotating/sliding seal may be re-located in a region outside the housing.

In this connection it is preferable for the filling pipe to be drivable substantially synchronously by a drive means.

It is also preferable to arrange a sealing member which is optionally reciprocable between an open and a closed position, in order to obtain the seal between the feed aperture in the cover and the filling pipe.

In another embodiment of the clothless invertible filter centrifuge according to the invention the drum and the cover are driven by means of a rotated hollow shaft and a reciprocable supporting shaft is arranged in the hollow shaft, enabling the drum base to be displaced relative to the drum wall or the filtering medium of the drum wall for mechanical discharge of the filter cake.

More specifically it is preferable here that a screw spindle be arranged on the supporting shaft and a nut engaging the screw spindle be provided, and that either the screw spindle or the nut may be driven in rotation by a motor, so that the supporting shaft telescopes to and fro in the hollow shaft dependent on the speed of the screw spindle or nut relative to the speed of the hollow shaft. This enables the cover to be opened while the filtering drum is rotating and the drum base to be slid forwards for mechanical discharge of the filter cake through the free end of the drum.

This avoids the use of hydraulic units for the discharging/inverting movement of the drum base; leakages can essentially not be excluded with such units. These are extremely undesirable when filtering highly sensitive products such as pharmaceuticals or in processes which take place under sterile conditions.

In centrifuging machines, and accordingly in the clothless invertible filter centrifuge according to the invention, it is necessary to ensure that the drum can only be opened at comparatively low speeds for safety reasons. Centrifugal governors are available for this purpose, ensuring that the opening movement of the drum can only be initiated below a certain drum speed. This type of safety device is relatively complex and prone to trouble though, so a safety device which functions without using a centrifugal governor is preferable.

In the solution already put forward above, proposing a hydraulic unit to effect the opening and discharge movement of the cover and drum base respectively but avoiding hydraulic units, one possibility is particularly that a screw spindle should be arranged on the supporting shaft and a nut engaging the screw spindle be provided, that either the screw spindle or the nut may be driven rotatably by a motor, so that the supporting shaft telescopes to and fro in the hollow shaft dependent on the speed of the screw spindle or nut relative to that of the hollow shaft and drum, the drum opening when the speed of the screw spindle or nut driven by the motor is higher than that of the hollow shaft and closing when the speed of the screw spindle or nut is lower than that of the hollow shaft, and that the maximum speed of the motor should be chosen so that the maximum speed imparted by it to the screw spindle or nut is lower than the critical speed of the drum, so that the drum opens only when it is rotating at a speed lower than the critical speed.

Hence all this embodiment requires is monitoring of the speed of the drive motors, which can be accomplished very easily without malfunctioning.

Alternatively the screw spindle or nut may be drivable by a plurality of motors which may be switched on optionally at different speeds, and the maximum speeds of these motors may be chosen so that the maximum speeds imparted by them to the screw spindle or nut are lower than the critical speed of the drum.

Another alternative comprises arranging a controllable switching mechanism between the motor and the screw spindle.

In the embodiments of the clothless invertible filter centrifuge according to the invention where opening and sliding forward of the drum base relative to the drum are effected by a shaft (described as a sliding shaft) arranged in a hollow shaft, the sliding shaft passes through the interior of the centrifuging drum when the drum base slides forwards, and pollution may be caused, e.g. by lubricants, through these materials being carried from the machine frame into the interior of the drum. Conversely suspension residues, residues of filter cake material and/or filtrate may be introduced into the machine housing by the sliding shaft when the drum is being closed. These are both disadvantageous, for the pollution may impair the sterile conditions required in the interior of the drum for treatment of sensitive suspensions e.g. food or pharmaceuticals, while suspension residues which pass into the machine frame may adversely affect the centrifuging operation, particularly the movement of the sliding shaft.

A remedy may be provided by arranging a flexible and/or expansible partition wall between the closed end wall of the centrifuging drum and the drum base movable relative thereto, the wall providing a seal between the sliding shaft carrying the drum base and the interior of the drum receiving the suspension.

It is advantageous to check whether the partition wall is undamaged and can thus fulfil its function correctly; a means for monitoring a differential pressure between pressures prevailing on both sides of the wall is preferably provided.

The differential pressure may be monitored and an alarm signal triggered if the desired level is not obtained, so that the operating staff can react immediately to leakage of the partition wall and change it.

Another development of the centrifuge according to the invention consists of providing it with a device for undertaking a weighing measurement. Weighing may be done cheaply with low-load cells and weighing-out equipment, though disruptive forces occurring or caused through gas pressures in the centrifuge housing have to be compensated. A simple way of solving this problem is for the centrifuge to have a device for undertaking a weighing measurement, the centrifuge being mounted for rotating movement in a vertical plane, a force-measuring member sensing the weight-dependent rotating movements of the centrifuge and a compensating means compensating the disruptive forces caused by the fluctuating gas pressures, in such a way that the weighing process is not affected thereby, the compensating means further comprising a sensor for sensing the gas pressure in the centrifuge, which generates a correcting signal for the weight indication dependent on sensed changes in gas pressure.

The rotary axis of the centrifuge is then preferably horizontal.

Ease in cleaning centrifuging machines is especially important, particularly with such sensitive products as food and pharmaceuticals, so any parts of the machine coming into contact with the suspension to be filtered, the filtrate or the filter cake material should be readily accessible and cleanable. To facilitate this it is proposed, in a preferred embodiment of the invention, that the housing of the centrifuge should have a first chamber with an outlet for discharging a filtrate and a second chamber with an outlet for discharging the filter cake, the first chamber being sealingly enclosed by a first self-contained housing section and the second chamber being sealingly enclosed by a second self-contained housing section, the two housing sections further each being mounted for rotary movement in different directions about separate shafts, so that they can be rotated separately between a closed condition and an open condition relative to the centrifuging drum. This construction of the housing gives access to all the important components when the housing sections are rotated upwards, without the drum itself having to be dismantled.

Both housing sections are preferably mounted to rotate about vertical axes. The first housing section is preferably generally annular and the second housing section approximately cup-shaped with a substantially closed end wall, the second section being applied sealingly to the first section by an edge opposite the end wall in the closed state. The two housing sections form an approximately cylindrical surface arranged approximately concentrically with the drum.

In order to obtain the greatest possible separation when working with centrifuges according to the invention the drum is usually run at the highest possible speed, leading to very high peripheral speeds at its edge. As wobbling movements of the drum occur in these centrifuges due to inevitable imbalance, an annular gap is generally provided between the rotating centrifuging drum and the stationary housing in the region of the boundary between the filtrate chamber and the solids chamber; the annular gap may also contain a flexible, resilient seal.

If the drum inside such an annular gap is set in rapid rotation, the gap has to be at least large enough for the wobbling movement of the drum which occurs with maximum unbalance not to lead to contact between the rotating drum and stationary housing sections. If a seal is used in the annular gap it must only be applied lightly to rotating parts of the machine owing to the high peripheral speed of the drum and the heat produced by contact.

The effect of the annular gap, which is necessary in view of the inevitable wobbling movements of the drum, is that no absolute seal is possible between the filtrate chamber and the solids chamber of the housing.

As the centrifuging drum acts like a fan when rotating, an over-pressure relative to the solids housing section arises in the filtrate housing section, in which the closed drum rotates during the filtering process; the over-pressure is basically responsible for gas exchange between the filtrate and the solids chamber of the housing. The liquid which passes out through the filtering medium in the region of the drum surface during centrifuging is finely distributed in the filtrate chamber or filtrate housing section, i.e. the gas which is present there is enriched with liquid aerosols which can pass through the annular gap into the solids chamber. Although an external, so-called gas compensation pipe is often provided between the filtrate chamber and the solids chamber, ensuring pressure equalisation between the two chambers, undesirable transfer of liquid into the solids chamber through the annular gap may nevertheless take place as a result of the turbulence prevailing in the filtrate chamber. Furthermore liquid aerosols may of course also pass through the gas compensation pipe into the solids chamber, as can gas saturated with filtered liquid, which may then condense out undesirably in the solids chamber.

In the discharging movement of the drum base and the subsequent removal of solids on the other hand, the drum base is moved into the solids chamber like a plunger piston. Consequently an over-pressure arises in that housing section relative to the filtrate chamber, at least as long as the drum base is applied to the filter cake lying against the drum wall and slides it towards the open end. This prevents any reduction in pressure. Discharge by movement of the drum base causes the dry solids to be ejected into the solids chamber, and the gas present in that chamber is enriched with solid aerosols through powdery constituents of the solids.

Even if, as already mentioned, a gas compensation pipe is provided for pressure equalisation, the turbulence prevailing in the solids chamber during the ejection of solids—which also takes place with the drum rotating—may make solids pass undesirably through the annular gap into the filtrate chamber. Moreover, solid aerosols may again pass through the gas displacement pipe into the filtrate chamber.

Passage of filtrate into the solids chamber and conversely of solids into the filtrate chamber is highly undesirable owing to the contamination involved, but is virtually inevitable with the conventional annular gap arrangement, even if the gap contains a seal.

A solution to the problem is seen in the provision of an annular gap in a protective device between the housing and the centrifuging drum at the edge of the drum in the region of the filtrate housing section and solids housing section, whereby a stream of a gaseous blocking medium may be produced in the annular gap surrounding the edge of the drum, the blocking medium preventing undesirable transfer of gaseous, liquid and/or solid substances between the filtrate and solids housing sections or the filtrate and solids chamber.

The protective device is preferably designed so that it can produce two streams of a gaseous blocking medium in the annular gap, one stream being directed into the filtrate housing section or filtrate chamber and the other into the solids housing section or solids chamber.

It may still be advisable to provide a so-called gas compensation pipe. However it is preferably fitted with a check valve, so that when the protective device is working the gas compensation pipe can be blocked, thus avoiding any passage of filtrate liquid or solid aerosol in one direction or the other through that pipe.

For final drying of the solids component obtained from filtration with the clothless invertible filter centrifuge according to the invention it is beneficial for the centrifuge to have a downstream solids dryer. In conjunction with the centrifuge dehumidification and drying of the solids are then carried out in the centrifuge through centrifuging, compressing with pressurised gas and heat convection by means of a flowing drying gas, and in the solids dryer through heat convection by means of s flowing drying gas.

The centrifuging mechanically de-humidifies and dries the filter cake clinging to the drum wall or filtering medium, and the cake may be dried further by passing drying gas through it; the efficiency of the de-humidification and drying treatment naturally depends on the temperature and speed of the gas flowing through. In this connection experiments have been made in clearing the capillaries of the filter cake with a relatively high-pressure gas to open the way for the drying gas, before blowing the drying gas through the cake.

In cases where de-humidification and drying in the centrifuge are not sufficient, thermal units in the form of solids dryers are arranged downstream of the centrifuge, in which units the solids removed from the centrifuge are treated by heat contact through heating and/or heat convection by means of a flowing drying gas, to achieve further de-humidification and drying of the solids to the desired final level. In many cases it is necessary to obtain the required final degree of drying (residual moisture) in a final drying step under vacuum. De-agglomeration of the solids by alternate application of vacuum and pressure may also be necessary. Final drying or de-agglomeration is generally effected by vacuum in solids dryers, although these processes can basically also be carried out in the centrifuge.

The drying gas may be air or a different gas, particularly an inert gas. If it is contaminated with noxious matter in the de-humidification and drying operation in both the centrifuge and the solids dryer it must be either disposed of or processed in a treatment plant, so that the purified drying gas can be re-used in the de-humidifying and drying circuit in the centrifuge and dryer and use of fresh gas is minimised.

When solids pre-dried in the centrifuge are transferred to the solids dryer large agglomerates of solid often cause trouble; these may be formed by excessive compression and/or excessively strong capillary linkage forces. In that case de-agglomeration, i.e. reduction in size, must be carried out before the solids enter the dryer.

In uncoupled operation of the centrifuge and solids dryer, i.e. with each apparatus dimensioned and controlled separately in view of the result to be achieved for a certain product, the size of each apparatus must depend on the worst-case drying results, and the dwell time in the centrifuge or dryer may become too long e.g. owing to missing batches included in the calculation.

In known installations where the centrifuge and solids dryer are operated separately, neither the results of de-humidification and drying in the centrifuge nor those of dehumidification and drying in the solids dryer can be matched to each other, and hence assemblies comprising a centrifuge and a solids dryer are often unprofitable owing to waiting or stoppage times. Such assemblies are also often designed to an excessive safety level with a view to fulfilling certain expectations for the product, and this may have a direct negative effect on the manufacturing costs of the assemblies and their operating costs.

The degree of de-humidification which can be obtained by mechanical centrifuging in the invertible filter centrifuge may also be limited, so the separated solids may adhere or be baked on in undesirable places e.g. due to their thixotropic action, and may make further movement of the product into the solids dryer difficult. Here again undesirable stoppages may take place. Additional equipment may also be necessary, which similarly increases the necessary investment.

Consequently the centrifuge according to the invention is preferably combined into a unit with a downstream solids dryer, so that the centrifuge and dryer complement each other synergetically in operation, to obtain a certain degree of de-humidification (residual moisture); use of the heat energy of the drying gas in particular has to be optimised, i.e. minimised.

This is achieved particularly in that the centrifuge also comprises a downstream solids dryer, de-humidification and drying of the solids taking place in the centrifuging drum through centrifuging, compression with pressurised gas and heat convection by means of a flowing drying gas, and in the solids dryer through heat convection by means of a flowing drying gas.

With the functional components consisting of the centrifuge and solids dryer combined it then becomes possible for the invertible filter centrifuge and solids dryer to be joined to form a unit by a closing means which allows sealed separation of the invertible filter centrifuge and solids dryer, sensors being arranged on the invertible filter centrifuge and solids dryer to measure the degree of humidification and drying prevailing there and other operating parameters applying there, such as the weight of the contents of the drum, the pressure, temperature, through-flow rate and/or pH of the filtrate, and the speed, moisture and in-flow rate of the suspension supplied, a joint control means being provided, which may be actuated by the readings provided by the sensors and, dependent on these, adjusts the operating data such as the speed of the centrifuge, a gas pressure, the flow speed of a gas and/or the temperature of a gas and possibly the temperature of the surfaces in contact with the solids, the control means automatically adjusting these operating data so that the operating times for dehumidification and drying in the centrifuge and in the solids dryer are coordinated, and at the same time the mechanical centrifuging energy on the one hand and the thermal energy in the invertible filter centrifuge and solids dryer on the other hand are shared to the economic optimum.

The main idea in operating such an installation is to divide the drying work optimally between the invertible filter centrifuge and the solids dryer dependent on the product and result; if necessary the de-humidification and drying processes will be carried out in the solids dryer rather than the invertible filter centrifuge, and vice versa.

A further advantageous embodiment of the invention ensures that there is no trouble with the weight-dependent measurements in the centrifuge even when an over pressure or under pressure is introduced into the drum.

In a first version this is achieved, in that a pipe is provided to produce an over pressure or under pressure in the drum, and the line of action of the force generated in that pipe by the over pressure or under pressure is directed so that it intersects the rotation axis of the machine housing.

In a second version a pipe is again provided to produce an over pressure or under pressure in the drum, and a sensor for sensing the pressure in the drum corrects the measurement indicator dependent on pressure.

The invention further concerns a method of separating a suspension into a filtrate and a solids component using a clothless invertible filter centrifuge according to the invention as described in detail above.

In this method the suspension is conveyed through the filling pipe into the interior of the drum, the filtrate passing or being pushed through the filtering medium by virtue of the centrifugal forces prevailing when the drum rotates, and the solids component being retained on the inner wall of the drum i.e. by the filtering medium. When the centrifuging step is over the solids component retained by the filtering medium is mechanically discharged from the drum by means of the drum base.

It has already been mentioned above that the diameter of the drum base is as near as possible to the internal width of the drum at the closed end, so that as little solids component as possible is left in the drum during mechanical discharge.

The solids component can be cleaned off the filtering medium of the drum virtually completely with pneumatic assistance, i.e. by generating streams of gas which are made to flow through the filtering medium from outside into the interior of the drum, to loosen the solids component and/or detach it from the filtering medium.

The streams of gas are preferably formed by producing low pressure inside the drum. Alternatively pressure conditions may be applied to the periphery of the drum.

It is also preferable for the streams of gas to be applied in the form of one or more pressure or low pressure pulses; this produces a comparable effect, and also minimises the volume of gas flowing through.

A radially inwardly directed flow through the filtering medium may preferably be provided before the solids component is mechanically discharged by the drum base, as this may loosen the filter cake formed by the solids component and reduce its adhesion to the filtering medium.

This measure assists in the as far as possible complete discharge of the solids component mechanically, through the sliding movement between the drum wall and the drum base.

In a particularly preferred method according to the invention, following the mechanical discharge of the solids component by the drum base, the drum base is returned to its starting position adjacent the closed end wall of the drum, then residues of the solids component left on the filtering medium are conveyed pneumatically out of the drum by means of streams of gas acting in a radial and/or axial direction.

The drum base may remain in its withdrawn position, i.e. its starting position, or again be transferred to its ejecting position to further assist the pneumatic cleaning mechanically.

The streams of gas acting in a radial direction may be produced synchronously with the movement of the drum base, beginning in a position adjacent the starting position of the drum base and continuing towards its ejecting position. Ideally an annular stream of gas is produced at the periphery of the drum and flows into the drum, shortly before the drum base passes over that part of the drum wall.

The radially acting streams of gas produced may be stationary with the drum rotating, thereby ensuring that every surface component of the drum is impinged on by those gas streams. In this way uniform cleaning of the whole surface of the filtering medium in the drum can be obtained.

It is further preferred that the radially acting streams of gas are superimposed by axially acting streams of gas, which achieves a better pneumatic conveying effect for discharging the residues of the solids component.

In a similar fashion as the radially acting streams of gas can be made to act in synchronism with the drum base movement, the axially acting streams of gas can be produced in synchronism with the transfer of the drum base moving from its starting position to its ejecting position.

These and other advantages and advantageous embodiments of the centrifuge according to the invention will now be explained in greater detail with reference to the accompanying drawings.

### BRIEF DESCRIPTION OF THE DRAWINGS

FIG. 1 shows a first embodiment of an invertible filter centrifuge according to the invention in the centrifuging position;

FIG. 2 shows the FIG. 1 invertible filter centrifuge in the discharging position;

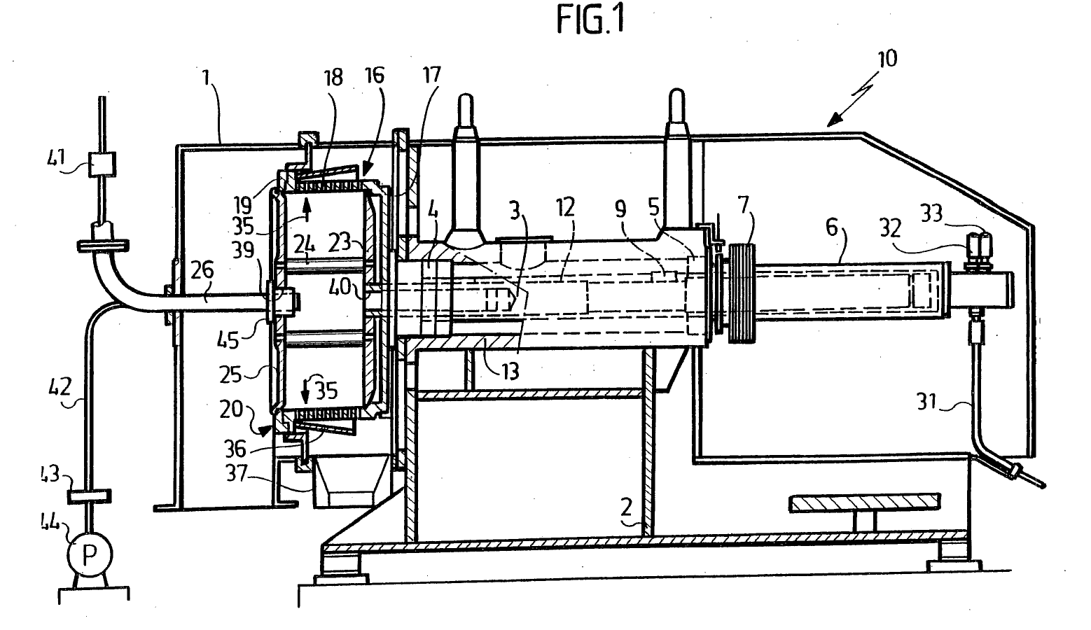

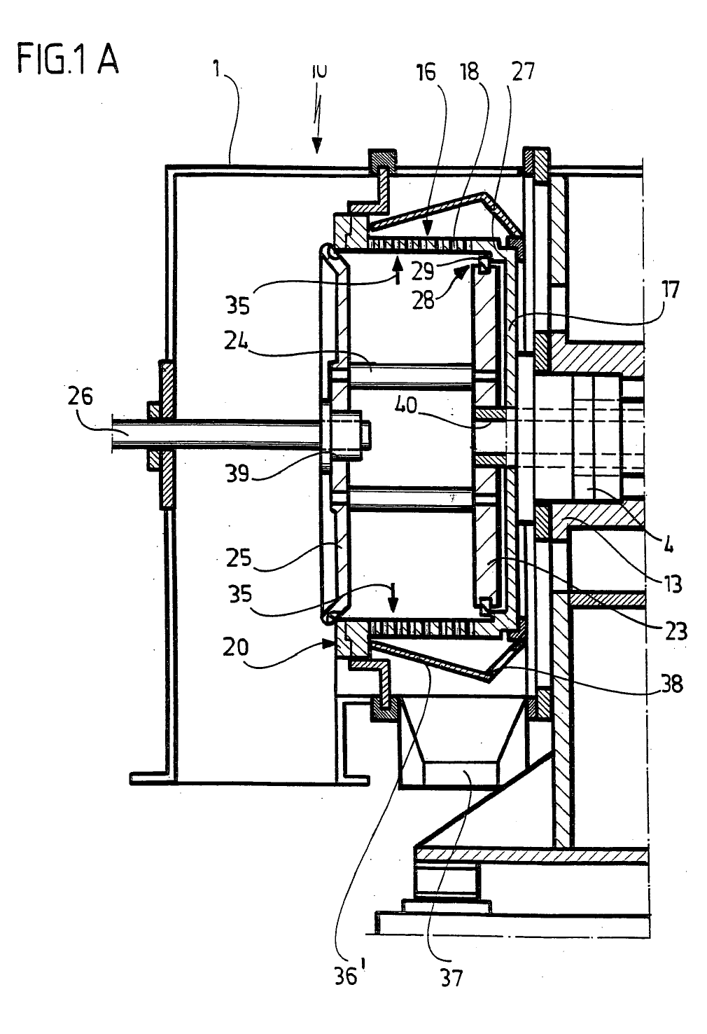

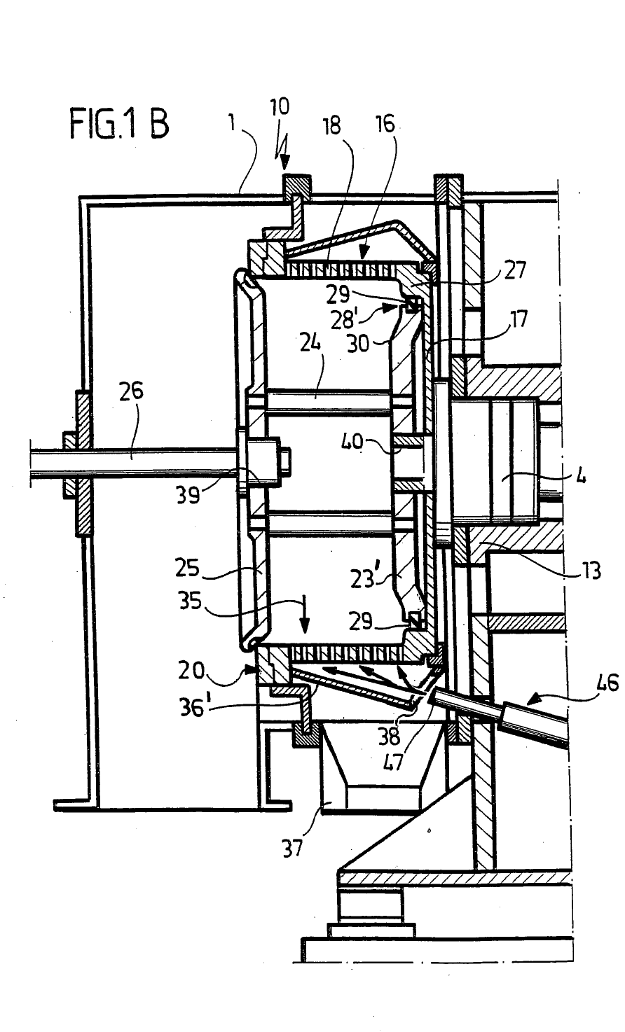

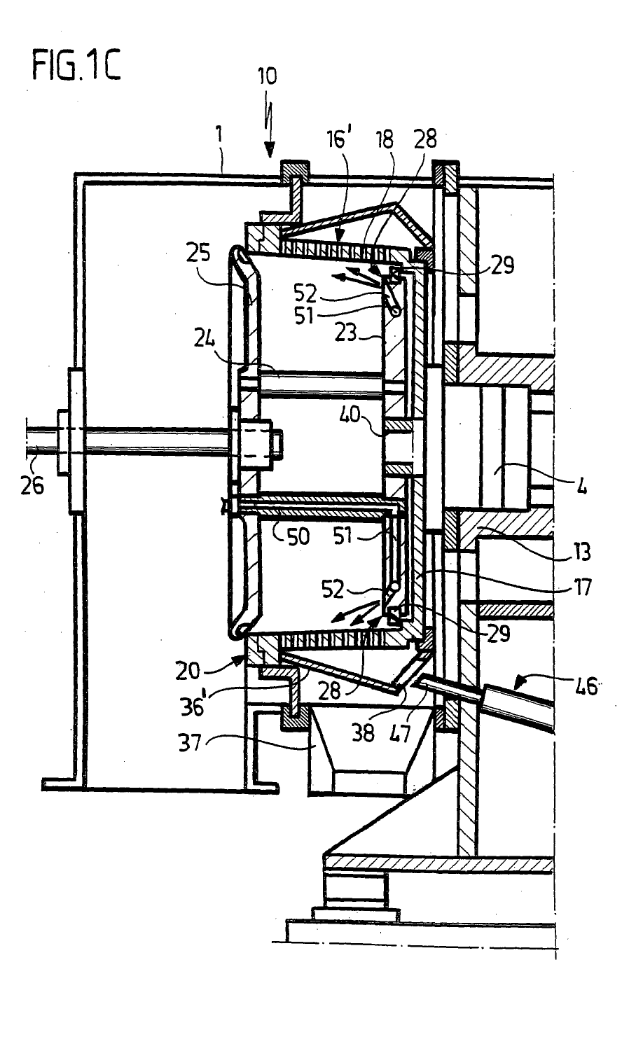

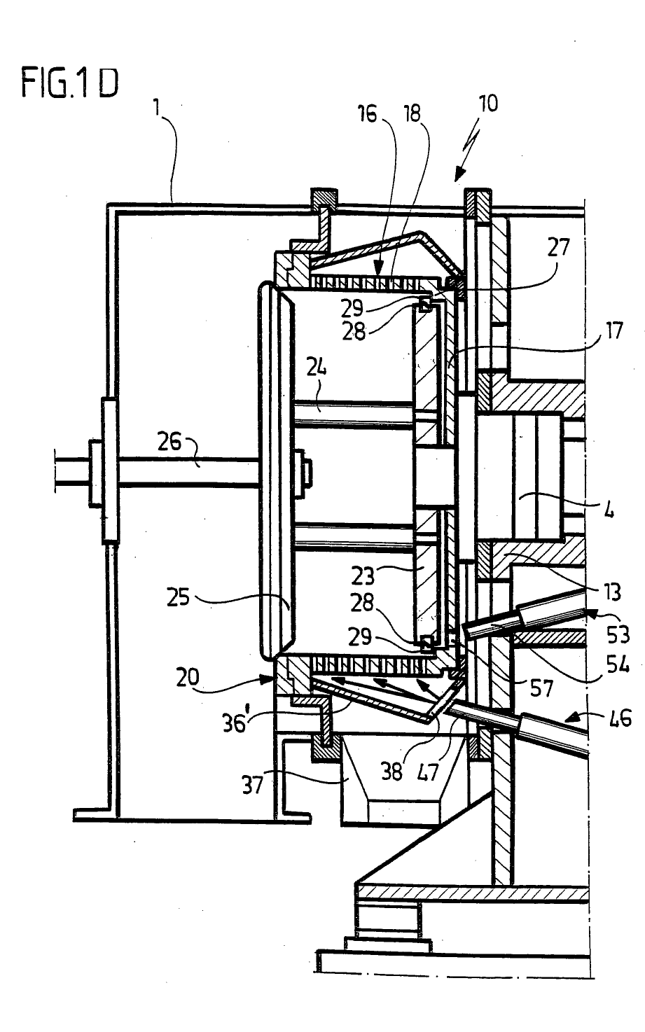

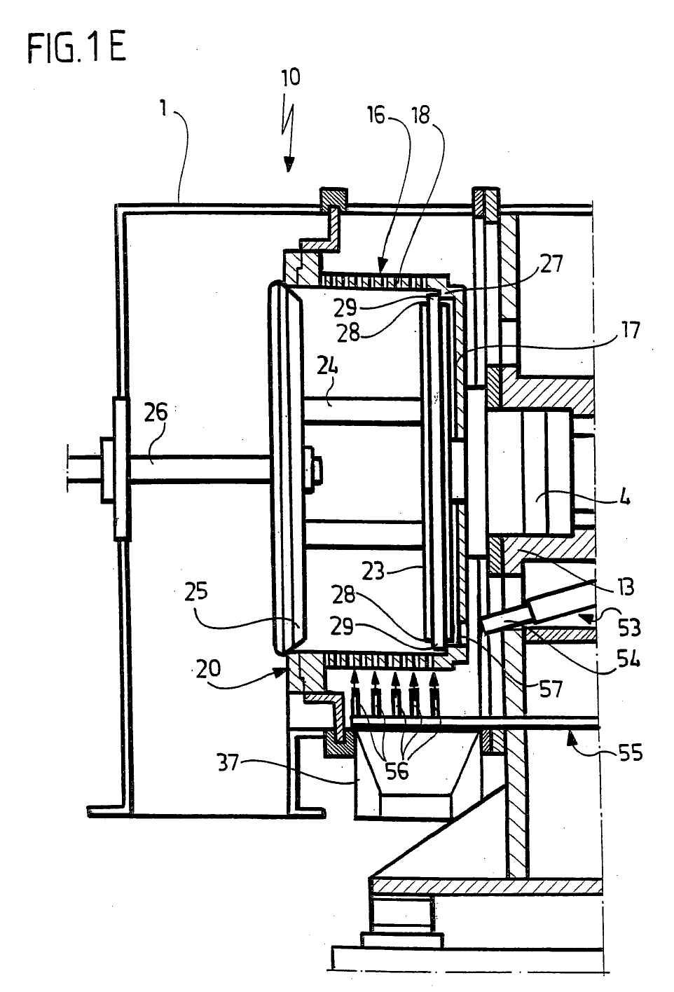

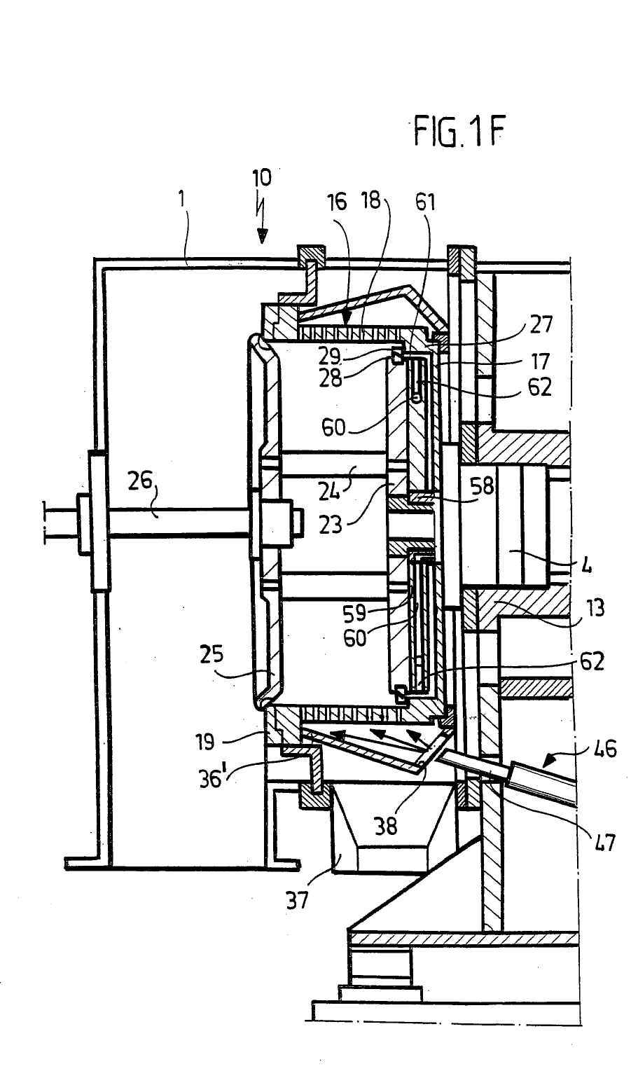

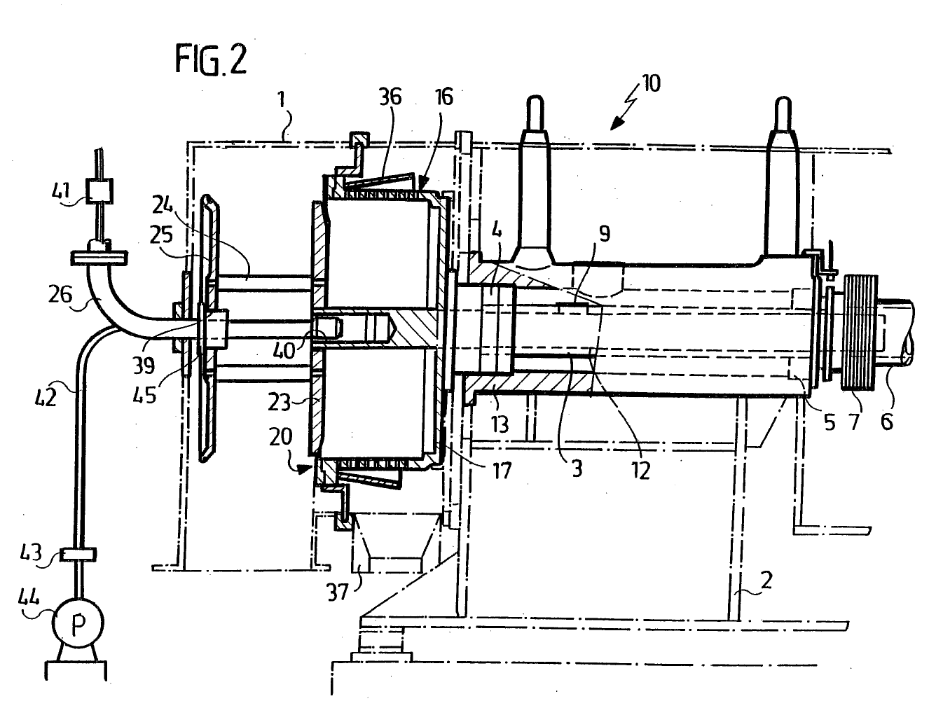

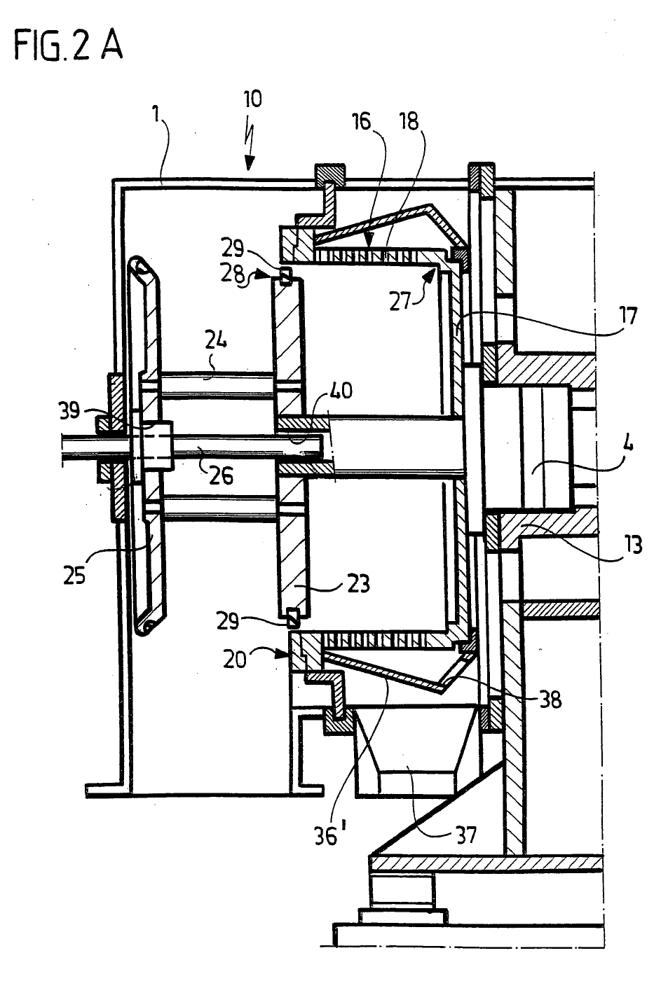

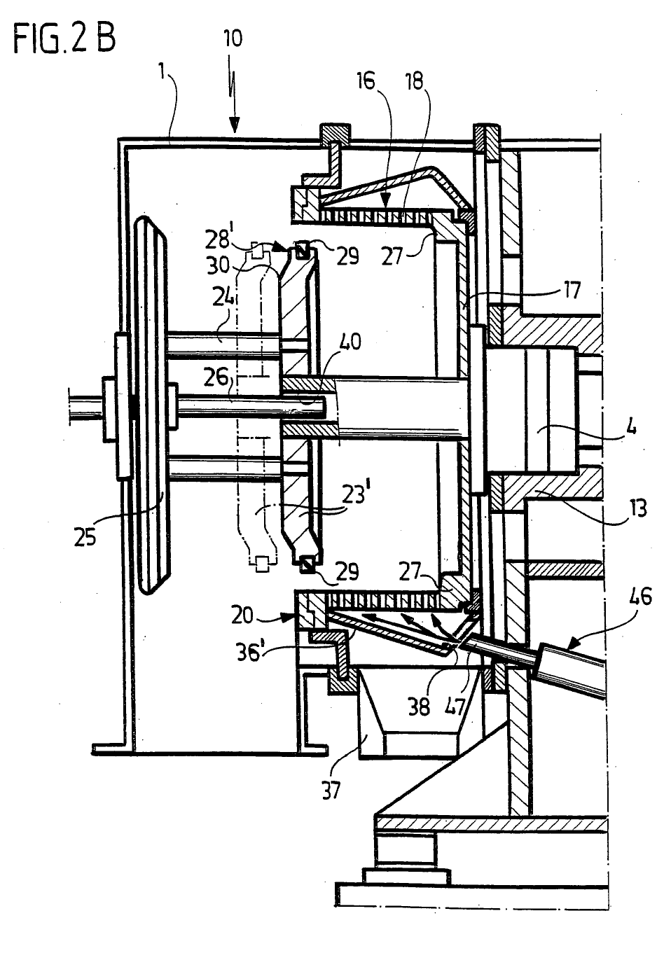

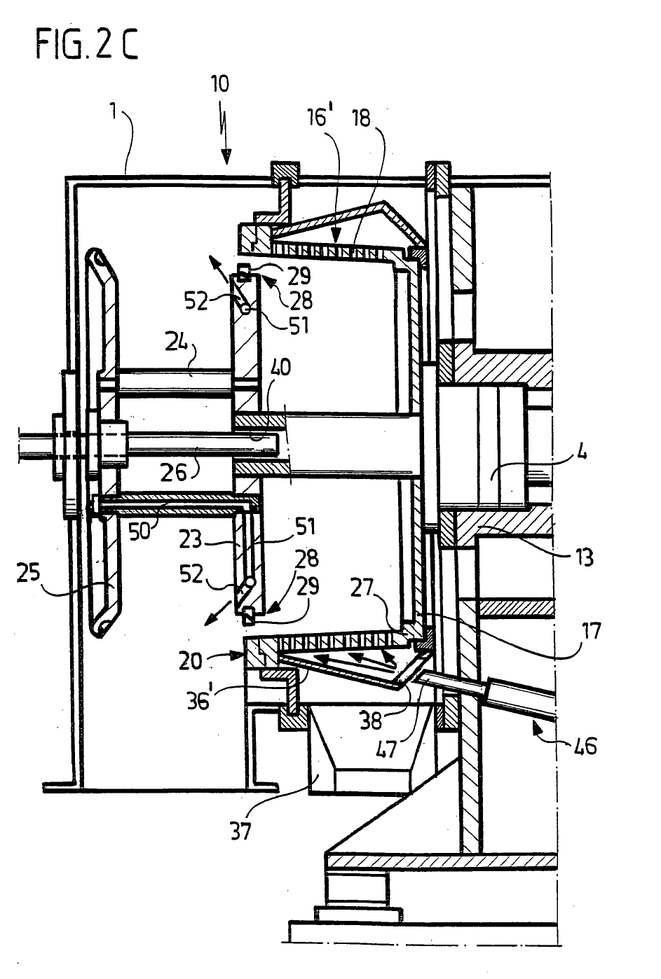

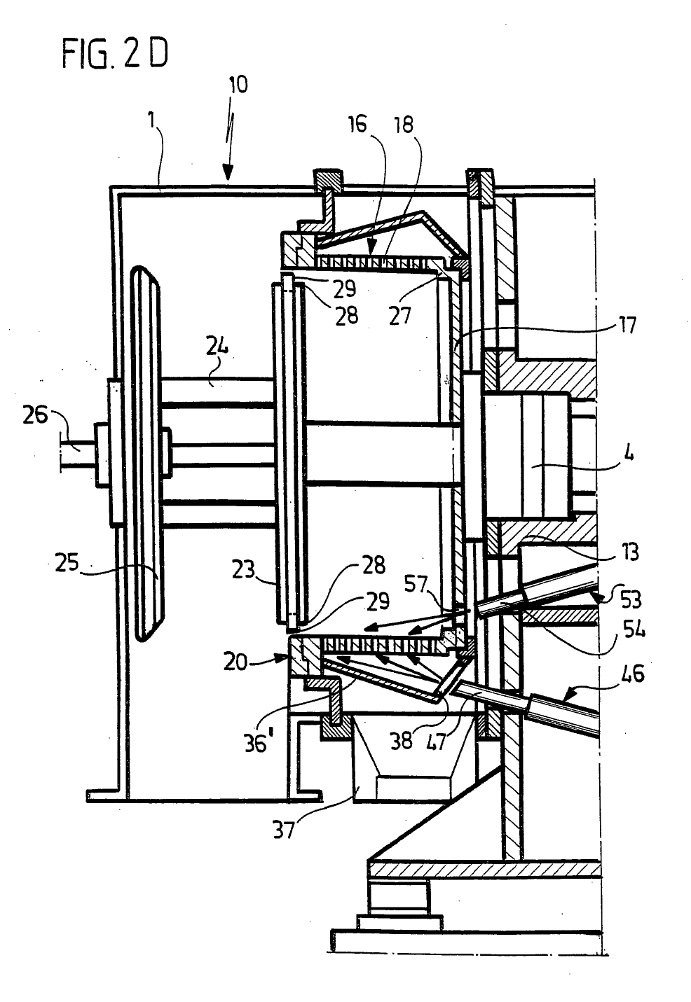

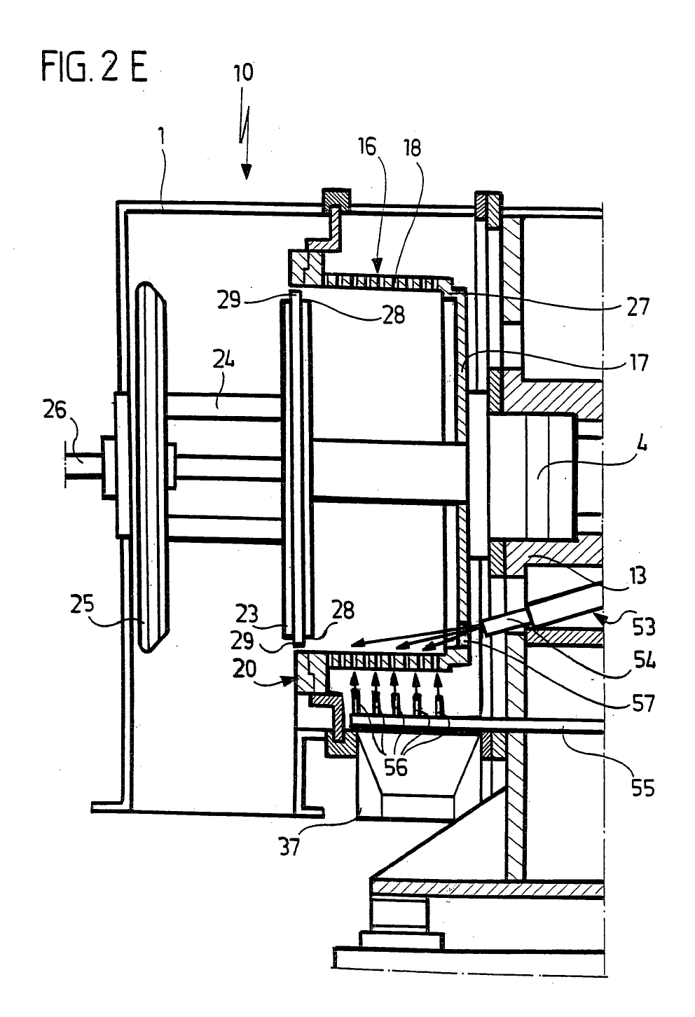

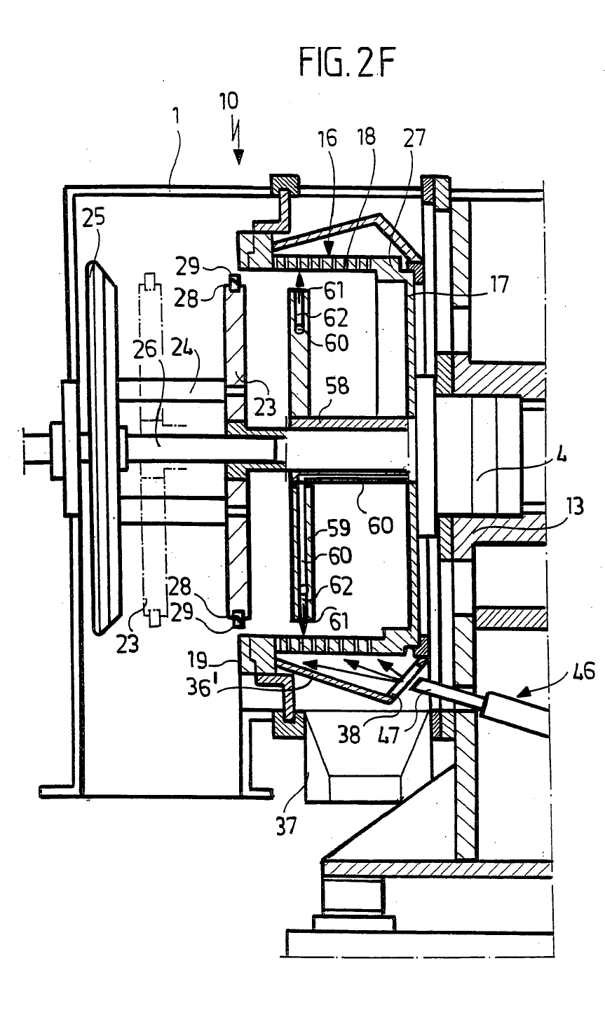

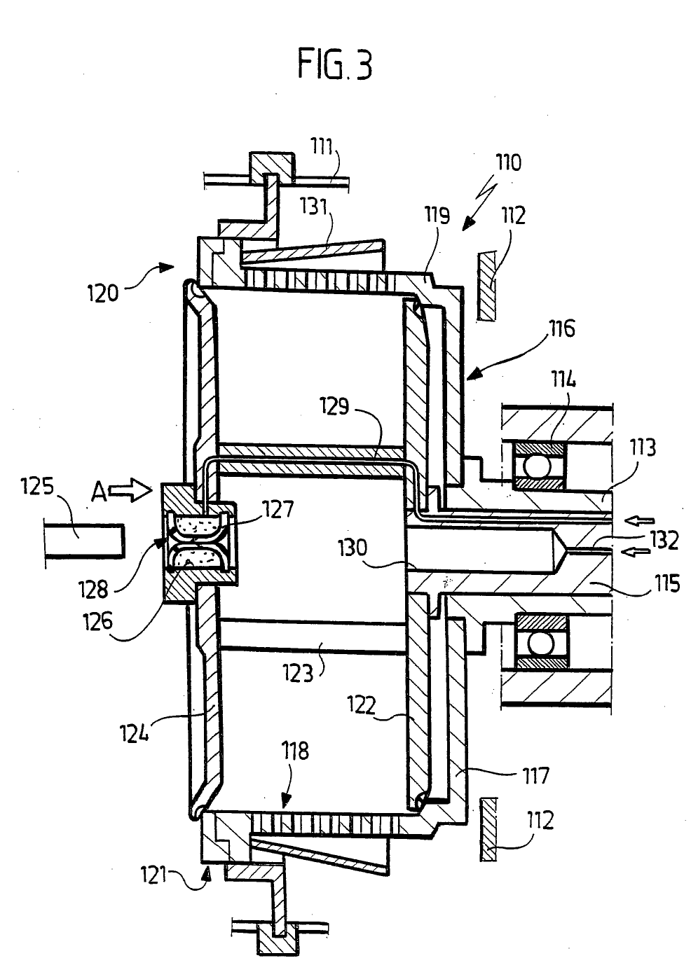

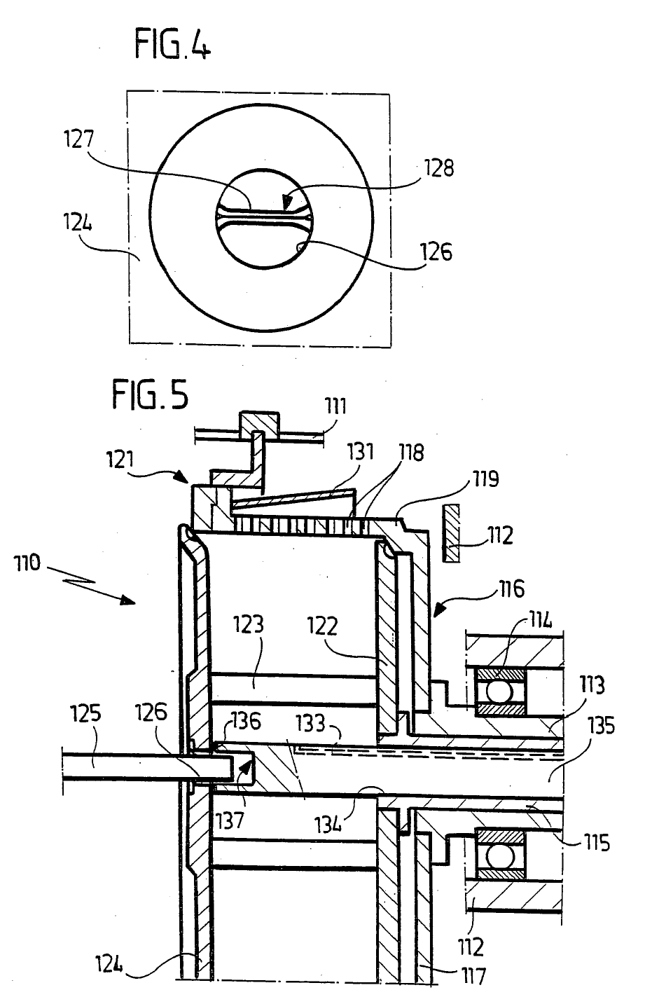

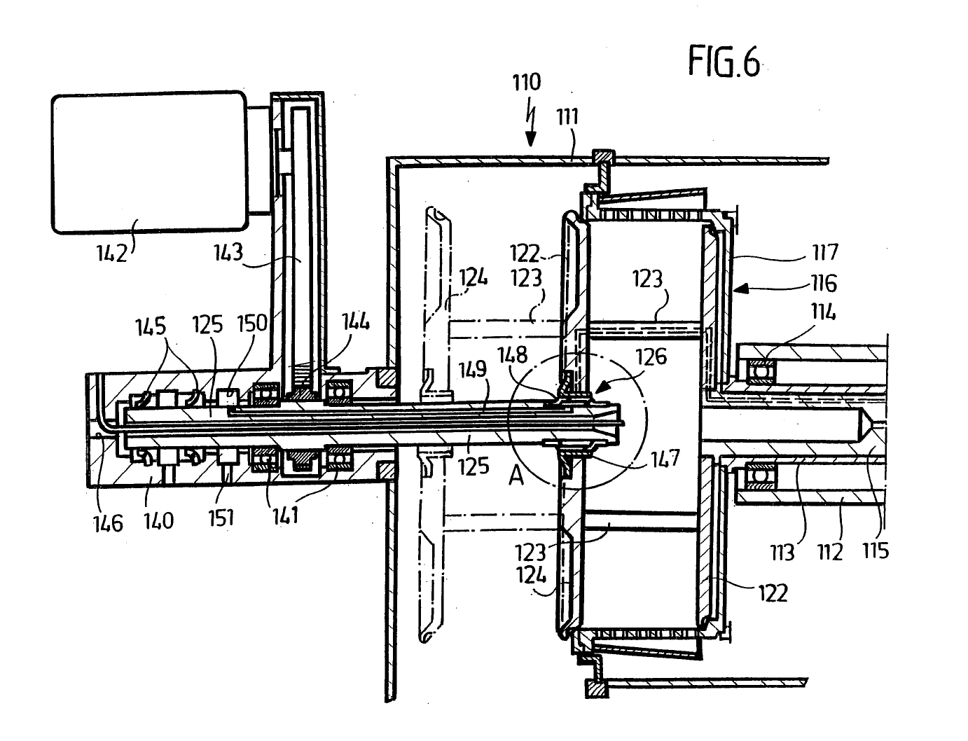

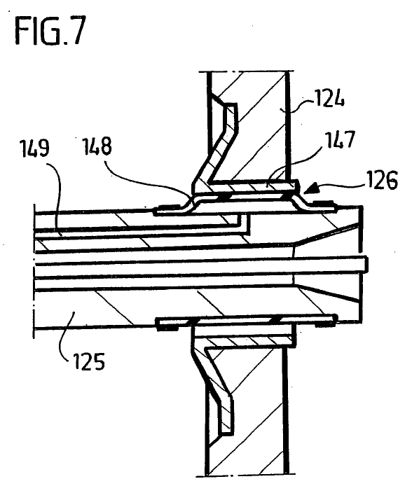

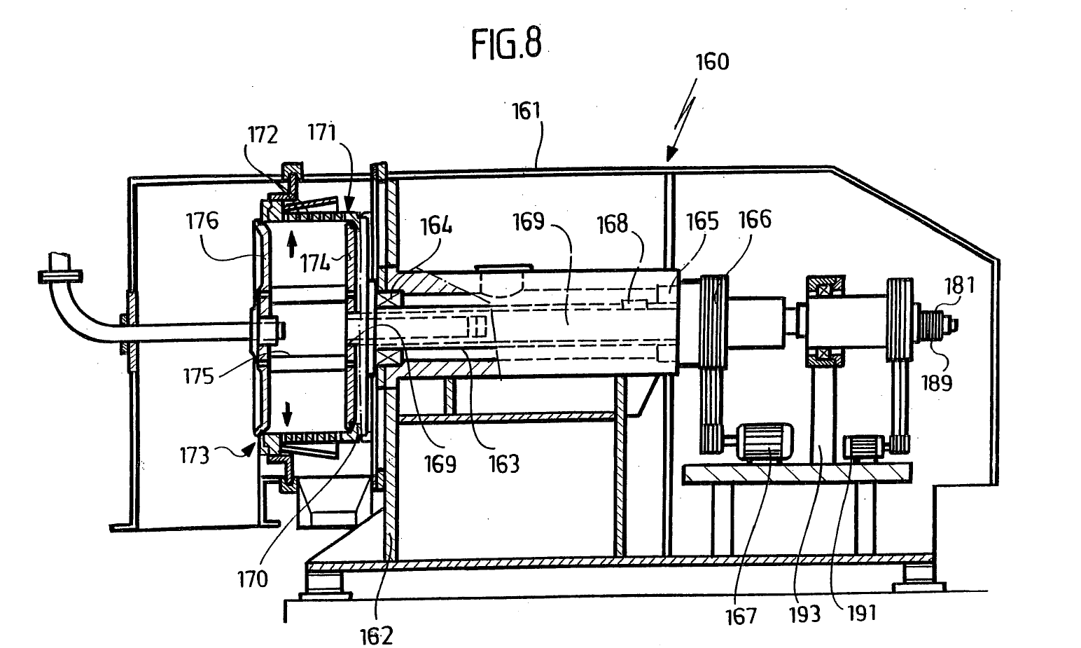

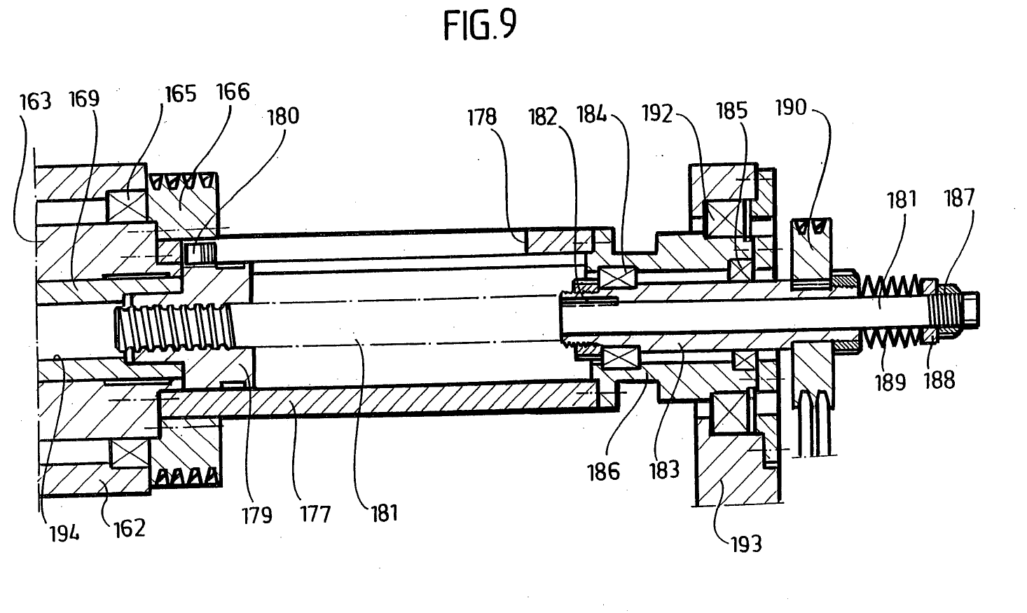

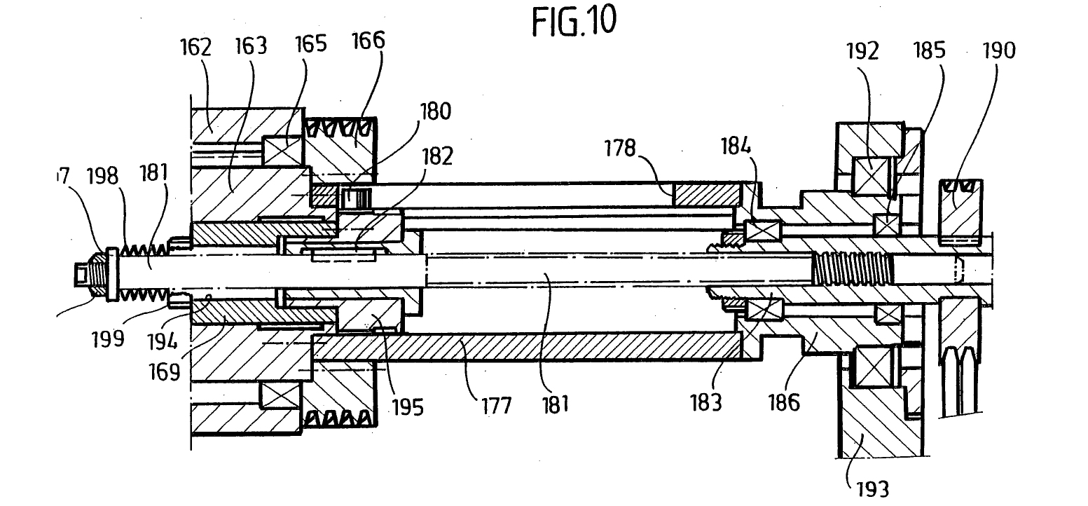

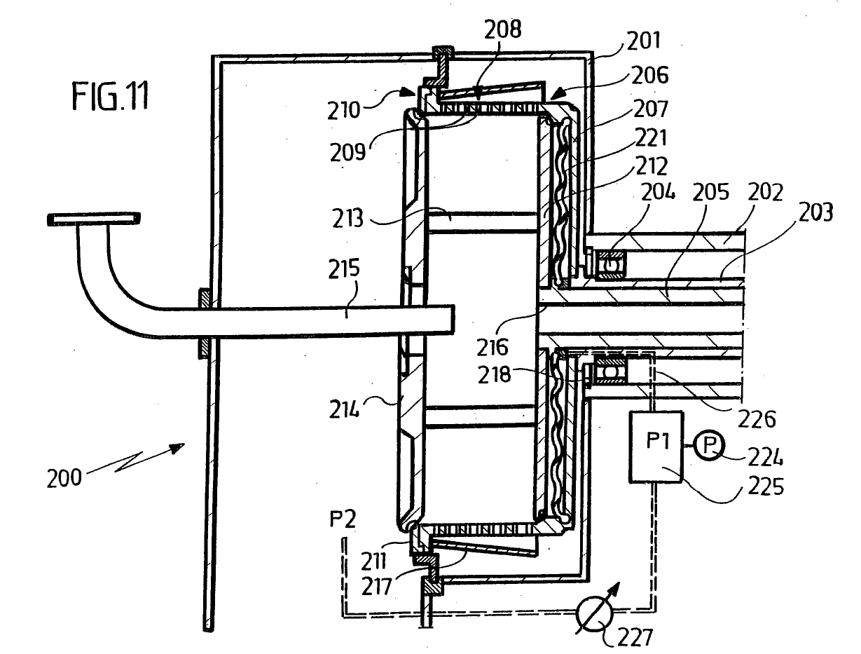

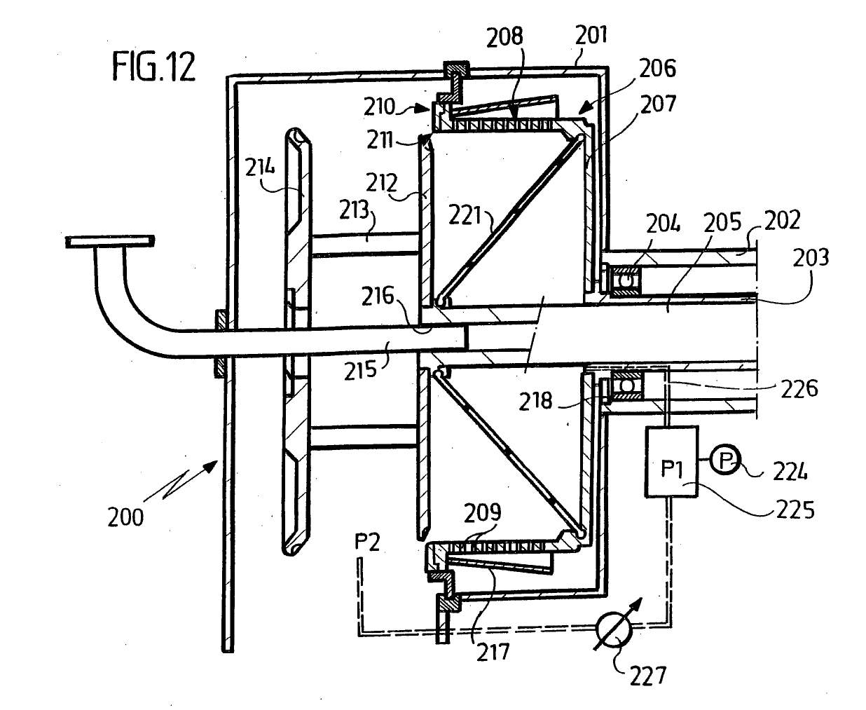

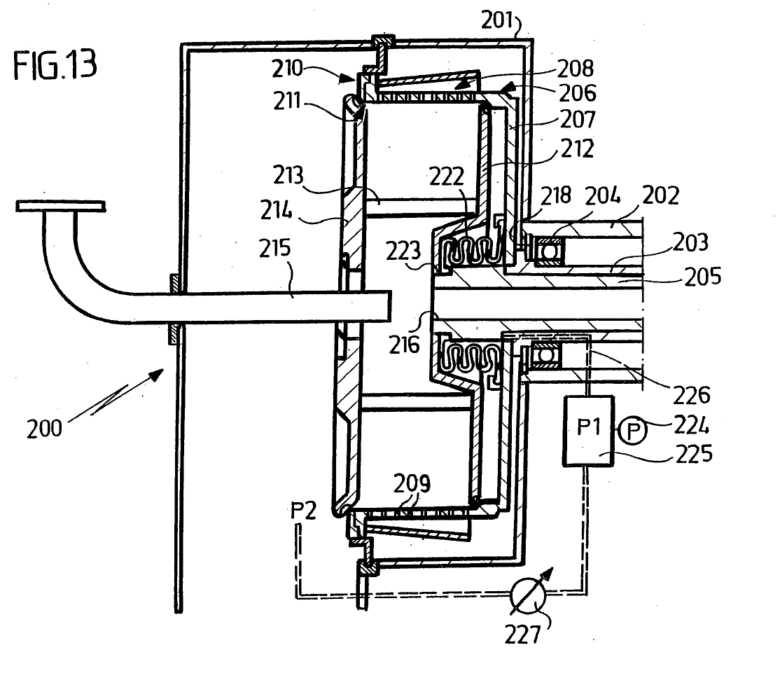

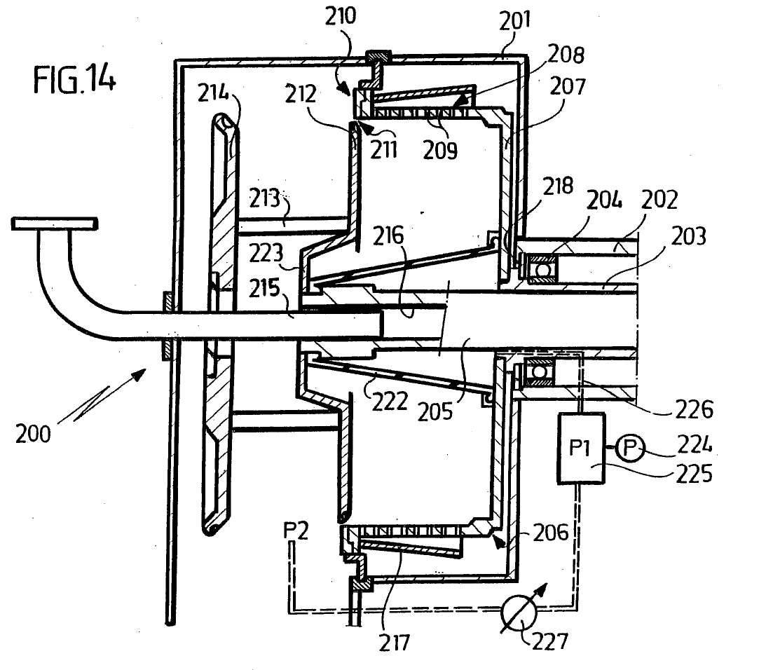

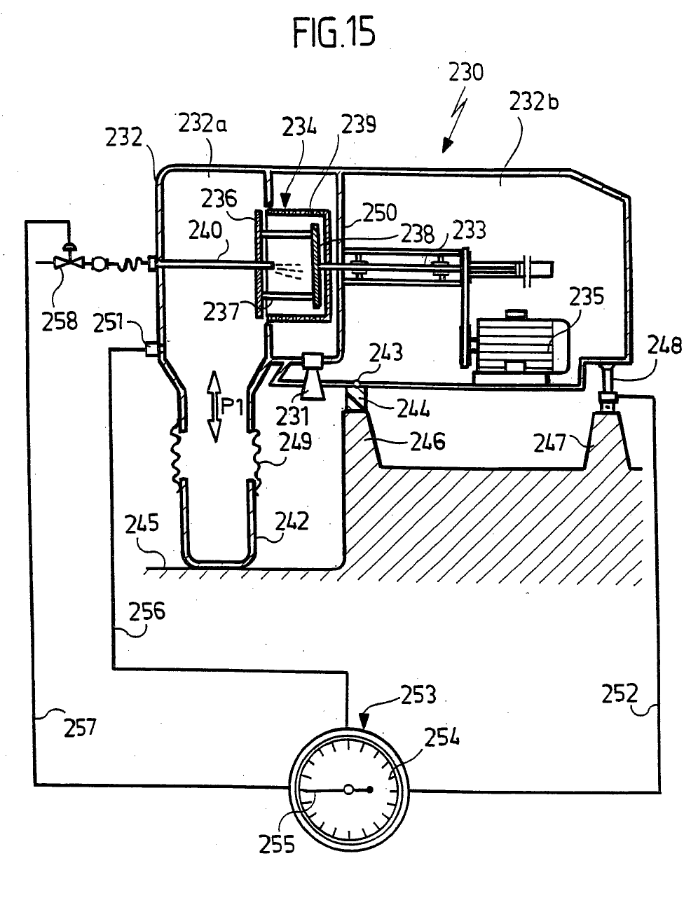

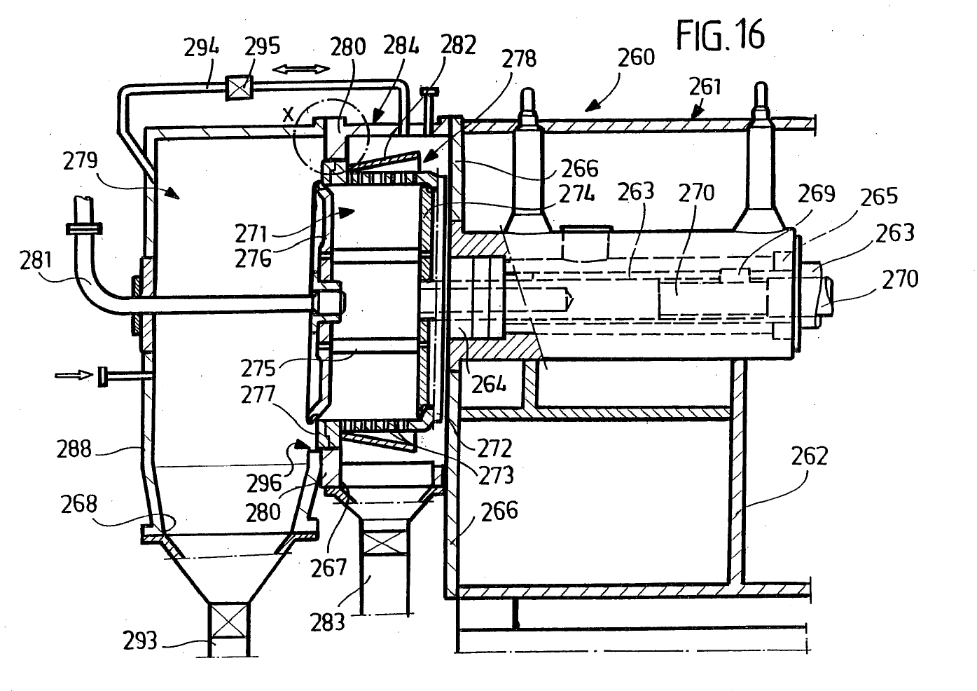

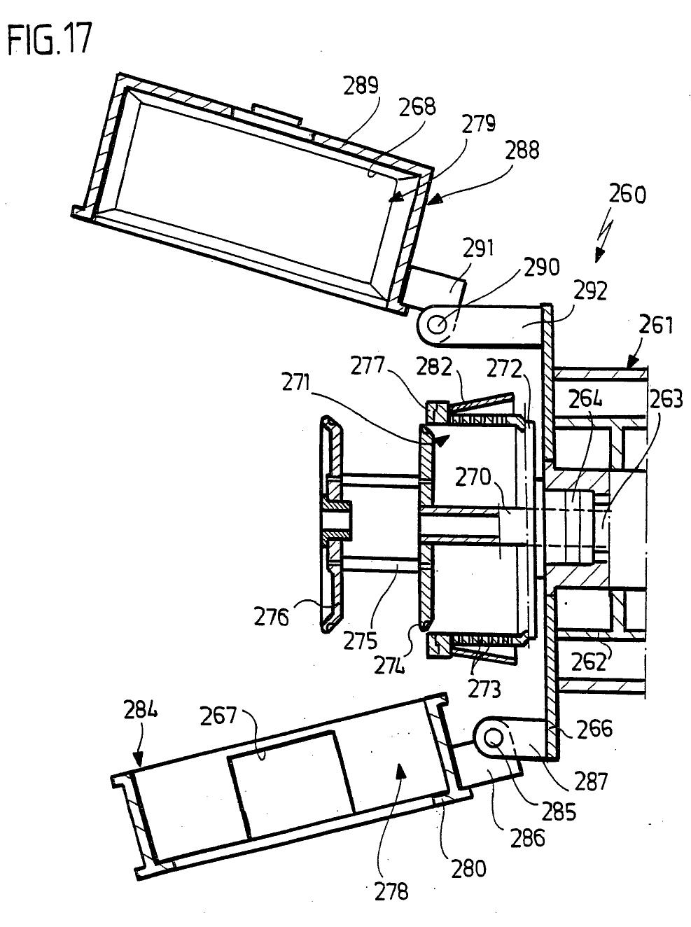

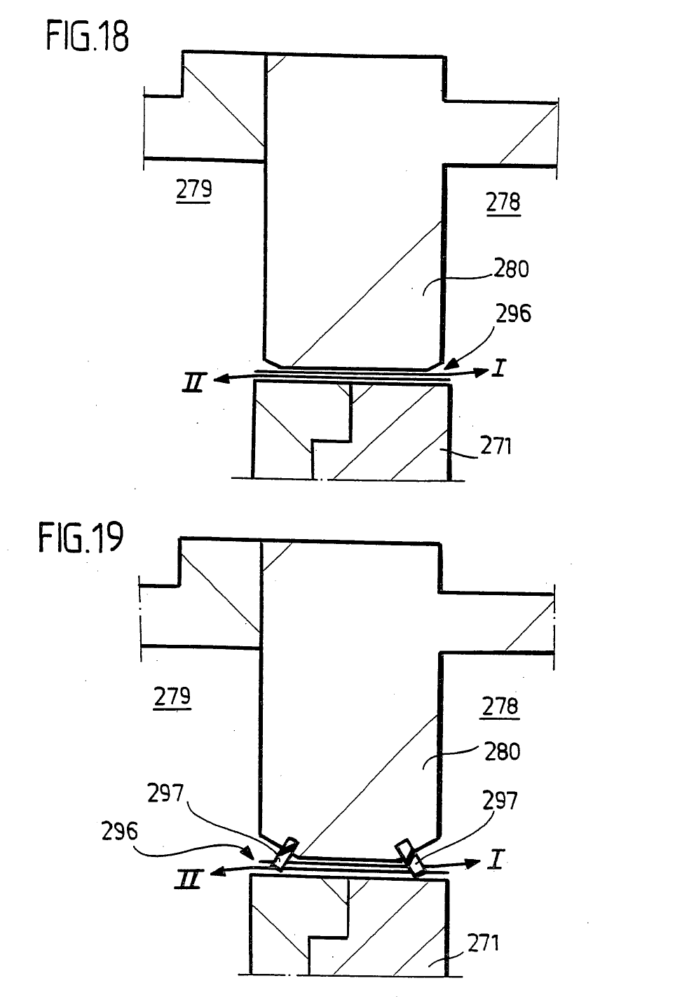

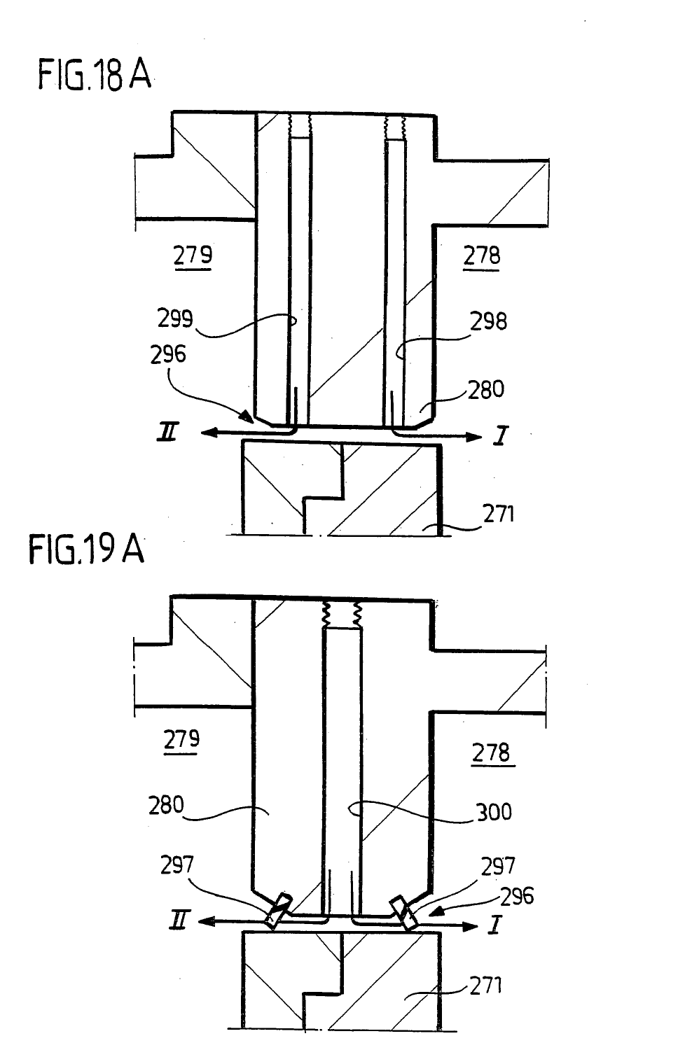

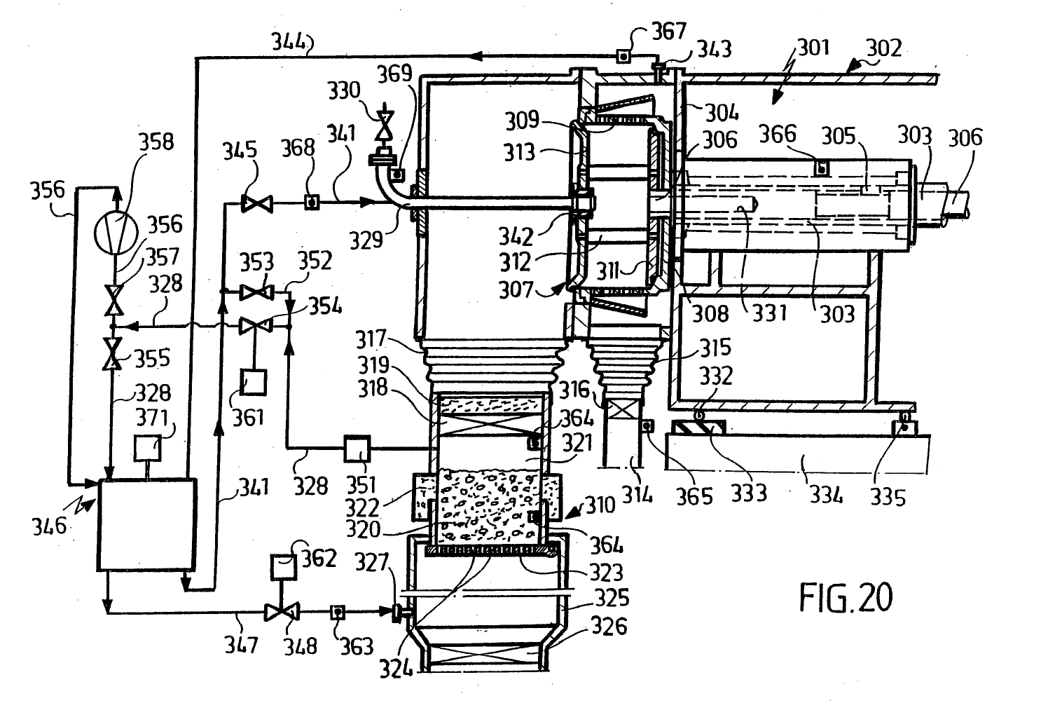

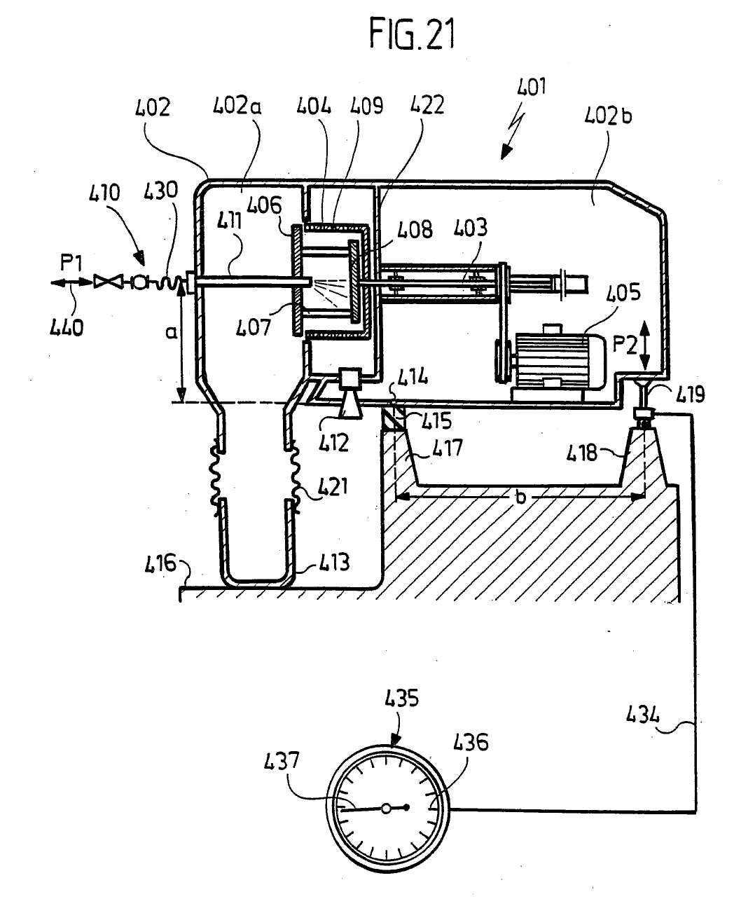

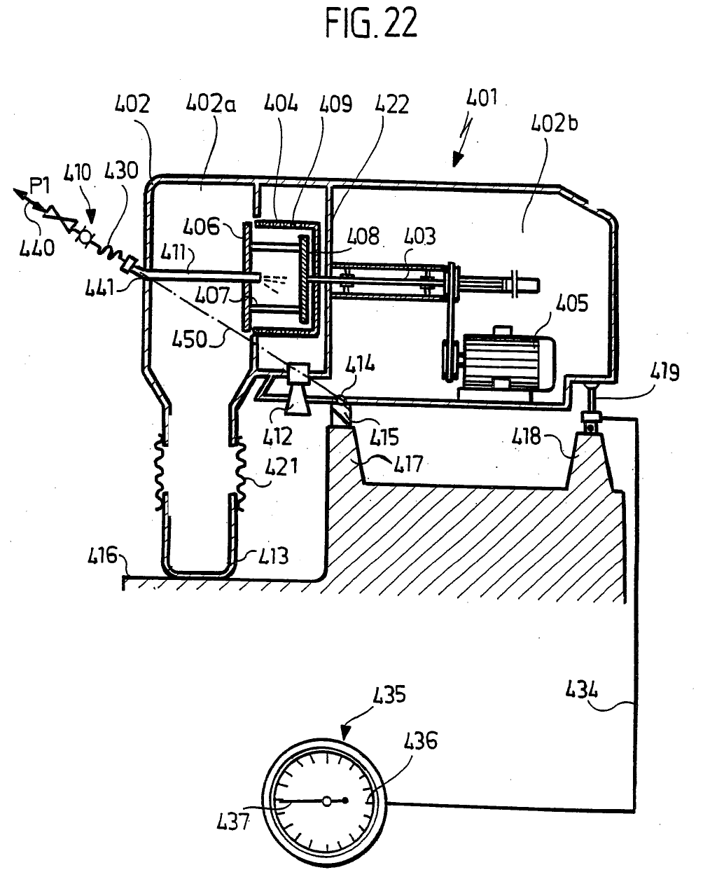

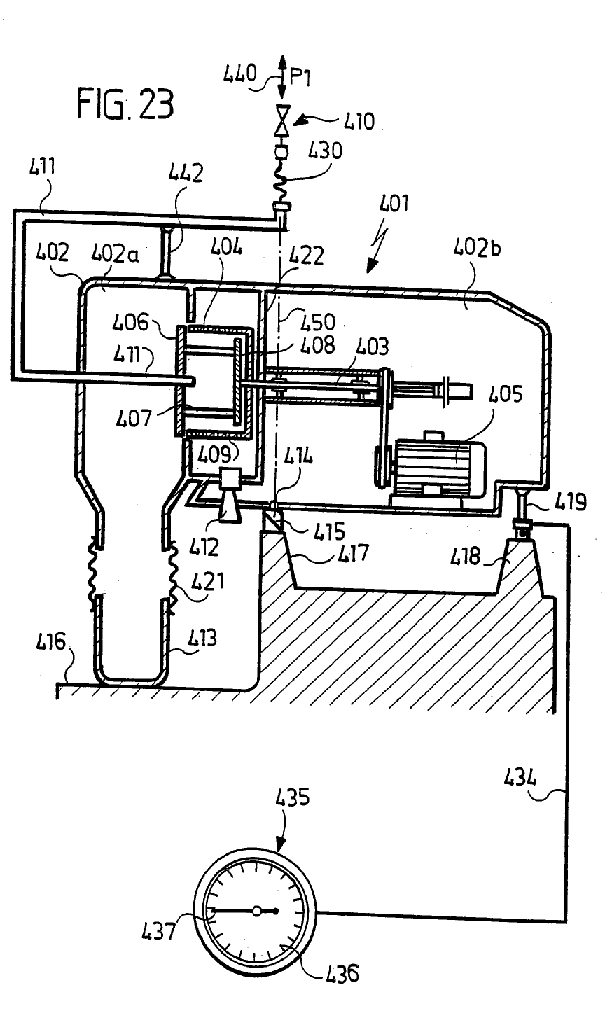

FIGS. 1A and 2A show larger-scale details of the centrifuge according to the invention in FIGS. 1 and 2;

FIGS. 1B to 1F and 2B to 2F show variations on the first embodiment of the invertible filter centrifuge according to the invention with different additional pneumatic discharge means, in larger-scale partial representations corresponding to FIGS. 1A and 2A;

FIG. 3 shows another version of the FIG. 1 invertible filter centrifuge according to the invention without a filter cloth and with a tightly sealing cover;

FIG. 4 is a plan view of the cover of the invertible filter centrifuge, seen in the direction of the arrow A in FIG. 3;

FIG. 5 is another version of the FIG. 3 clothless invertible filter centrifuge according to the invention;

FIG. 6 is a further embodiment of the clothless invertible filter centrifuge according to the invention with a tightly sealing cover;

FIG. 7 is a larger-scale detail of the seal on the cover (detail A in FIG. 6);

FIG. 8 is another embodiment of the clothless invertible filter centrifuge according to the invention;

FIGS. 9 and 10 are details of possible alternative structures for the drive shafts of the FIG. 8 centrifuge;

FIG. 11 is a further embodiment of the clothless invertible filter centrifuge according to the invention;

FIG. 12 shows the FIG. 11 centrifuge with the cover lifted off;

FIG. 13 is a further embodiment of the clothless invertible filter centrifuge according to the invention;

FIG. 14 shows the FIG. 13 centrifuge with the cover lifted off;

FIG. 15 is a further embodiment of the clothless invertible filter centrifuge according to the invention;

FIG. 16 is a further embodiment of the clothless invertible filter centrifuge according to the invention with a housing section divided in two and adapted to be rotated away;

FIG. 17 shows the FIG. 16 centrifuge with housing portions rotated away;

FIGS. 18, 19, 18A, 19A are larger-scale representations of detail X in FIG. 16;

FIG. 20 is an embodiment of the clothless invertible filter centrifuge according to the invention with a drying means combined to form a unit; and

FIGS. 21 to 23 show a further embodiment of the clothless invertible filter centrifuge according to the invention with a weighing means free from disturbing forces.

### DETAILED DESCRIPTION OF THE INVENTION

The invertible filter centrifuge without a filter cloth, shown in FIG. 1, comprises a housing 1 (indicated only diagrammatically) sealingly enclosing the whole machine and containing a hollow shaft 3 mounted rotatably in bearings 4, 5 on a stationary machine frame 2. The housing 1 is generally of a pressure-resistant design in order to contain the pressures occurring when the necessary processing steps are taken, e.g. approx. 1 to 2 bar during vapour sterilisation. A pressure medium cylinder 6 is flange-mounted sealingly on the end of the hollow shaft 3 projecting beyond the bearing 5 at the right hand side of FIGS. 1 and 2. A drive wheel 7 is joined non-rotatably to the cylinder 6 and enables the cylinder 6 and thus the hollow shaft 3 to be set in rapid rotation by an electric motor (not shown) e.g. by means of a V-belt.

The hollow shaft 3 extending rigidly between the bearings 4, 5 has an axially directed wedge-shaped groove (not shown), in which a wedge 9 can be moved in an axial direction. The wedge 9 is rigidly connected to a shaft 12 which is displaceable inside the hollow shaft 3. The shaft 12 therefore rotates together with the hollow shaft 3 although it is axially displaceable within it.

The shafts 3 and 12 extend in a bush-like housing 13 supported on the machine frame 2 and also serving to hold the bearings 4, 5.

A cup-shaped centrifuging drum 16 is flange-mounted by its closed end wall 17, cantilevered and non-rotatably, on the end of the hollow shaft 3 projecting beyond the bearing 4 at the left hand side of FIG. 1. The cylindrical wall of the drum is largely formed by a filtering medium 18, e.g. a multi-layer metal net filter which becomes large-pored in a radially outward direction, or a sintered ceramic filter with similar properties. The drum 16 is open at the end 20 opposite the closed end 17.

The displaceable shaft 12 passing freely through the closed end wall 17 is rigidly connected to a base 23 of the drum.

A centrifuging chamber cover 25 is rigidly fixed to the drum base 23 by stay bolts 24, leaving an intermediate gap; the cover seals the centrifuging chamber of the drum 16 by lying on the flange-like edge 19 of its opening and, together with the drum base 23, can be lifted free of the drum 16 through the shaft 12 sliding out of the hollow shaft 3 in an axial direction. In another embodiment the drum 16 may also be axially displaceable relative to the stationary cover 25 and the drum base 23, for the same purpose.

A filling pipe 26 is arranged at the front of the clothless invertible filter centrifuge, at the left hand side of FIG. 1; its function is to feed a suspension, which has to be divided into its solid and liquid constituents, into the centrifuging chamber of the drum 16 (FIG. 1), and in the operative condition shown in FIG. 2 it passes into a hole in the displaceable shaft 12.

Pipes 31 and valves 32, 33 interacting with the pressure medium cylinder 6 serve to reciprocate the displaceable shaft 12 carrying the drum 16.

When the invertible filter centrifuge is in operation it first assumes the FIG. 1 position. The displaceable shaft 12 is drawn back into the hollow shaft 3 and the pressure medium cylinder 6, and the drum base 23 joined to the shaft 12 is therefore near the closed end wall 17 of the centrifuging drum 16. The cover 25 of the centrifuging chamber has thereby been applied to the edge 19 of the opening of the drum 16 with a sealing action. With the drum 16 in rotation suspension requiring filtering is fed in through the filling pipe 26. The liquid constituents of the suspension pass through the filtering medium 18 of the drum 16 in the direction of the arrow 35 and are guided by a baffle plate 36 into an outlet pipe 37. The solid particles of the suspension are retained by the filtering medium 18.

With the centrifuging drum 16 continuing to rotate, the shaft 12 is moved (to the left) as shown in FIG. 2, whereby the drum base 23 is moved to the open end of the drum 16, carries the filter cake, formed by solid particles, out of the drum 16 and throws it into the housing 1. From there the solid particles can easily be removed. In the FIG. 2 position the filling pipe 26 has passed through openings 39, 40 provided in the cover 25 and the drum base 23 respectively into the hole in the shaft 12. When the removal of the filter cake is over the filter centrifuge is returned to the operative position in FIG. 1 by sliding back the shaft 12. In this way the centrifuge can run with the centrifuging drum 16 constantly rotating.

As shown diagrammatically in FIG. 1 a valve 41 is fitted in the filling pipe 26; it interrupts the supply of suspension and seals off the pipe from a storage vessel containing the suspension. A pipe 42 with a check valve 43, leading into the filling pipe 26, together with a pump 44, enables a gas, particularly compressed air or an inert gas, to be fed into the filling pipe 26 and thus into the centrifuging chamber of the drum 16. The internal pressure thereby created in the drum 16 raises the hydraulic pressure which obtains in the centrifugal force field of the rotating drum 16 and thus has altogether a favourable effect on the filtration result, as evidenced by the drying of the filter cake.

In another embodiment it is possible to introduce hot, pressurised steam or solvent vapour through the pipe 42 and thereby subject the filter cake which has built up to vapour washing.

In a further embodiment of the invention an under pressure rather than an over pressure may be produced in the drum 16, e.g. by having the pump 44 in FIG. 1 in the form of a suction pump. Such under pressure applied for a time may e.g. have a favourable effect in releasing the filter cake from the filtering medium 18.

If an over or under pressure prevails in the drum 16 a pressure-tight seal 45 has to be formed between the stationary filling pipe 26 and the cover 25 of the drum 16 running round it. A well-tried solution for this is known from DE 37 40 411 A1.

In the inverting movement carried out by the drum base 23, which can be seen from FIGS. 1 and 2, the filter cake is largely discharged from the interior of the drum 16. However, as the diameter of the drum base 23 always has to be at least slightly smaller then the inside diameter of the drum 16 at the closed end wall 17 in order to avoid wear on the filtering medium, a residue of filter cake is left in the centrifuging drum 16. If substantially residue-free discharge of filter cake is required it is advisable to provide a pneumatic device for releasing and discharging filter cake residues, as can be seen from the larger-scale details from FIGS. 1B to 1F and 2B to 2F. The preferred alternative solutions for the clothless invertible filter centrifuge according to the invention will now be explained.

FIGS. 1A and 2A show a detail from the invertible filter centrifuge according to the invention in FIGS. 1 and 2, and for this reason the same references are used. It will be seen from FIGS. 1A and 2A that the drum base 23 carries a sealing member 29 running round its edge 28.

In the initial position of the drum base 23, i.e. when it is next to the closed end wall 17, the sealing member 29 lies against the internal surface of the centrifuging drum 16 with a sealing action in the region of reference 27 (FIG. 1A). In this position the element 29 seals the interior of the drum, which is being filled with suspension through the filling pipe 26, from the interior of the drum remaining at the back of the base 23 to the closed end wall 17.

Instead of the baffle plate 36 a filtrate housing 36′ leading round the drum 16 is formed here as an alternative embodiment; it has an outlet 38 only at the bottom, near the discharge pipe 37.

Another version of the centrifuge 10 is shown in FIGS. 1B and 2B in which, as in FIGS. 1A and 2A, the drum 16 is surrounded by a filtrate housing 36′ discharging into the outlet 38. In this embodiment the drum base 23′ is slightly smaller in diameter and has an offset portion 30 running round its edge 28′. The edge 28′ of the drum base then again carries a seal 29 as shown in FIGS. 1A and 2A.

In this version a pneumatic device 46 is provided in addition to the mechanical means for discharging the solid constituents (filter cake); the nozzle outlets of the device 46 reach corresponding openings in the annular chamber formed by the filtrate housing 36′ around the drum 16. The nozzles 37 form streams of gas which lead radial inwards into the interior of the drum 16. If the pneumatic device 46 is activated before the cake is mechanically discharged by the drum base 23′, this loosens the solid constituent in the drum 16 and at least partly detaches it from the filtering medium 18. Easy and possibly more complete mechanical discharge of the filter cake can be obtained in this way.

In addition or alternatively the pneumatic device 46 may be actuated at a time when the filter cake has already been mechanically discharged and the drum base 23′ has been moved back to the position shown in FIG. 1B. In that case the pneumatic device 46 loosens and lifts any remaining residues of the solid component off the filtering medium, and the residues can be discharged from the interior of the drum into the housing 1, assisted if necessary by further displacement of the drum base 23′.

FIG. 2B shows an alternative discharging position of the drum base 23′ in dash-and-dot lines; in this position pneumatic cleaning and discharge of filter cake residues can be started immediately after the filter cake has been mechanically discharged by the drum base 23′.

If the drum base 23′ and cover 25 are rigidly interconnected the housing 1 may possibly have to be larger.

Another alternative embodiment is shown in FIGS. 1C and 2C, where the filter drum 16′ used widens slightly conically from the closed end wall 17 to the opening edge 19 of the drum.

The drum base 23 again has an edge 28 containing a sealing member 29 which runs round it. Compared with the embodiment in FIGS. 1A and 2A the centrifuge 10 here has an additional pneumatic device which sends pressurised gas through a pressurised gas pipe 50 into the drum base 23, from where distributing passages 51 lead to outlets 52 directed towards the filtering medium 18 in the wall of the drum adjacent the edge 28 of the drum base. These nozzles are arranged at regular intervals in the edge 28 of the drum base and direct the pressurised gas against the inside of the filtering medium 18 with an axial and a radial component.

The cleaning action carried out by the pneumatic device 46 to remove solid residues from the filtering medium 18, which makes gas flow from the exterior radially inwards through the filtering medium 18, is further assisted by the streams of pressurised gas emerging from the nozzles 52 at the edge of the drum base.

Provision may particularly be made for the drum base 23 to rotate inside the drum at a different frequency from the drum 16′ itself, so that the streams of pressurised gas emerging from the nozzles 52 sweep evenly over the inside of the drum wall and the filtering medium 18 and clean them evenly.

Here again it is advisable to return the drum base 23 from its initial position shown in FIG. 1C to its ejecting position shown in FIG. 2C for the cleaning process to discharge the solid residues.

To enable the pneumatic cleaning and discharge of filter cake residues to be started immediately after the mechanical discharge of the filter cake by the drum base 23, the drum base 23 may be moved into an ejecting position as shown in dash-and-dot lines in FIG. 2B.(if necessary with a correspondingly larger housing provided). Another alternative embodiment is shown in FIGS. 1D and 2D, where the pneumatic device 46 known from FIGS. 1B, 1C and 2B, 2C is firstly provided; this passes pressurised gas through the filtrate chamber from outside into the interior of the drum 16 through the filtering medium 18.

As in the embodiment in FIGS. 1C/2C there is again a pneumatic device which acts inside the drum and has an axial component in its streams of gas. A pneumatic device 53 of this type has nozzles 54 which direct streams of gas through apertures 57 (only indicated in the figures) in the closed end wall 17 at an acute angle onto the internal surface of the cylindrical wall of the drum and the internal surface of the filtering medium 18. The streams of gas may also be aligned paraxially.

Complete pneumatic cleaning and removal of solid residues from the drum 16 can thus be achieved in combination with the inwardly directed streams of gas produced by the pneumatic device 46. The drum base 23 could basically stay in an ejecting position while the pneumatic devices 46 and 53 are thereafter set in operation to clean all the solid residues off the surface of the filtering medium 18. With such an arrangement the cover 25 and drum base 23 are then preferably moved slightly further to the left (cf. dash-and-dot position in FIG. 2B), so that the pneumatically extracted solid constituents can pass into the housing 1 unimpeded.

In the alternative embodiment in FIGS. 1E and 2E a pneumatic conveyor 53 is firstly provided, with nozzles 54 which direct pressurised gas through apertures 57 in the end wall 17 (apertures only indicated) at an acute angle onto the surface of the filtering medium 18 inside the drum, while a further pneumatic device 55 with a plurality of nozzles 56 directs individually controllable streams of gas onto the drum 16 from outside. As the nozzles 56 can be controlled individually a conveying process can be created, beginning next to the closed end wall 17 and continuing to the opening edge 19 of the drum 16, assisted by the action of the streams of gas emerging from the nozzles 54, which are effective chiefly in an axial direction.

Here again the conveying means 53 and 55 for discharging solid residues from the drum 16 may be operated in the condition shown in dash-and-dot lines in FIG. 2B, i.e. with the cover 23 in the ejecting position. The two pneumatic devices 53 and 55 may be operated with a pulsing action and may exert this pulsing action either simultaneously or alternately.

FIGS. 1F and 2F show another alternative embodiment, in which a circular plate 59 carried by a shaft 58 is provided between the drum base 23 and the closed end wall 17 of the drum 16; channels 60 in the plate guide pressurised gas radially to the peripheral edge 61 of the plate 59, where the gas passes out from nozzles 62. The plate 59, hereinafter referred to briefly as the nozzle plate, is axially displaceable on its shaft 58, preferably independently of the movement of the drum base 23 so that, e.g. after a first mechanical discharging movement of the drum base 23 which puts most of the solid constituents into the housing 1 and in co-operation with the pneumatic device 46, gas can be blown onto the internal surface of the drum 16 and the internal surface of the filtering medium 18, starting next to the closed end wall 17, continuing to the edge 19 of the opening of the drum 16, and thus enabling solid residues to be successively cleaned off the internal surface of the drum 16 in an outward direction. The drum base 23 is preferably in the position shown in dash-and-dot lines in FIG. 2F for this process.

Provision may of course be made for the plate 59 to be moved synchronously with the motion of the drum base 23 towards the edge 19 of the opening of the drum and/or for the outlet nozzles 62 of the plate 59 to blow gas onto the internal surface of the drum 16 several times, in order to obtain particularly thorough cleaning of the internal surface of the drum 16 and filtering medium 18.

The nozzles 52 and 62 shown in FIGS. 1C/2C and 1F/2F at the peripheral edge of the drum base 23 and the peripheral edge of the plate 59 respectively may, given an appropriate structure of the feed pipes, be used for rinsing the almost cylindrical or respectively cylindrical wall of the drum with the filtering medium 18 with a liquid cleaning medium, preferably a solvent.

Separate nozzles and feed pipes may of course be provided for this process, so that the pneumatic device and the rinsing means can be kept separate.

The invertible filter centrifuge 110, of which a detail is shown in FIG. 3, comprises a housing 111 (indicated only diagrammatically) which encloses and seals the whole machine and in which a hollow shaft 113 is mounted rotatably in bearings 114 on a stationary machine frame 112. The end of the hollow shaft 113 at the right hand side (not shown), projecting beyond the bearing 114, is connected to a drive motor (not shown either) which can set the shaft 113 in rapid rotation.

A shaft 115 is arranged inside the hollow shaft 113 with resistance to torsion but displaceably. The shaft 115 rotates together with the hollow shaft 113 but is axially displaceable therein.

A cup-shaped centrifuging drum 116 is flange-mounted by its closed end wall 117, cantilevered and non-rotatably, on the end of the hollow shaft 113 projecting beyond the bearing 114 at the left hand side of FIG. 3. The drum 116 has a filtering medium 118 on its cylindrical wall 119. The side 120 of the drum 116 opposite the closed end wall 117 is open.

A drum base 122 is arranged in the interior of the drum parallel with the closed end wall 117 and is rigidly connected to the displaceable shaft 115 passing through the end wall 117. A centrifuging chamber cover 124 is fixed rigidly to the drum base 122 by stay bolts 123, leaving a space; it seals the centrifuging chamber of the drum 116 by lying on the edge 120 of the opening, and can be lifted free of the drum 116 together with the drum base 122 by axially sliding the shaft 115 out of the hollow shaft 112. In another embodiment the drum 116 may be axially displaceable relative to the stationary cover for the same purpose.

A filling pipe 125 for feeding a suspension which has to be divided into its solid and liquid components into the centrifuging chamber of the drum 116 is arranged at the front of the invertible filter centrifuge 110, which is at the left hand side of FIG. 3. For this purpose the free end of the pipe 125 is passed into the interior of the drum through a central insertion aperture 126 in the cover 124 and drawn back to the FIG. 3 position when the drum 116 has been filled.

The insertion aperture 126 can be closed by a squeeze valve 128 known per se and formed by a tube 127. The interior of the tube 127 can be filled with a hydraulic or pneumatic pressure medium through a pipe 129 passing through the shaft 115, one 123 of the stay bolts and the cover 124, thereby closing the squeeze valve 128 in pressure-resistant manner. This condition is shown in FIG. 4.

When the drum 116 is opened, i.e. when the cover 124 is lifted off the edge 121 of the drum by sliding the shaft 115, the filling pipe 125 in the FIG. 3 position can pass through the now open squeeze valve 128 in space-saving manner into a hole 130 in the shaft 115. The squeeze valve 128 is constructed so that when it is open there is virtually no friction between the tube 127 and the filling pipe 125.

The squeeze valve 128 described may be replaced by a different type of valve, e.g. a ball or sliding valve, so long as one ensures that such a closing element, rotating together with the drum 116, seals the drum at the insertion aperture 126 and, when open, allows the filling pipe 125 to enter without frictional engagement.

When the invertible filter centrifuge is in operation it first assumes the FIG. 3 position. The displaceable shaft 115 is withdrawn into the hollow shaft 113, with the result that the drum base 122 connected to the shaft 115 is near the closed end wall 117 of the centrifuging drum 116. The cover 124 of the centrifuging chamber has been placed tightly on the edge 121 of the opening of the drum 116. With the drum 116 rotating and the squeeze valve 128 open the suspension to be filtered is introduced through the filling pipe 125 which has been pushed through the open squeeze valve 128. When the filling pipe 125 has been withdrawn the squeeze valve 128 is closed (FIG. 4) and the drum 116 possibly set in faster rotation. The liquid constituents of the suspension pass through the filtering medium 118 of the drum and are discharged by a baffle plate 131. The solid particles of the suspension are retained by the filtering medium 118.

During this process an over pressure may be produced inside the drum 116 through a pipe 132 formed in the shaft 115. If necessary under pressure inside the drum may also be produced through the pipe 132. In other cases the internal pressure in the drum 116 need not be changed. It may nevertheless be important for the insertion aperture 126 to be tightly sealed by the squeeze valve 128 or other closing element.

When the filtering process is over, with the centrifuging drum 116 still rotating and the squeeze valve 128 now open (and the pressure or low pressure source possibly turned off), the shaft 115 is slid to the left, causing the drum base 122 to be moved to the open end 120 and transport the filter cake outwards into the housing 111. Solid particles of filter cake can easily be conveyed away from there. In this position of the drum 116 the filling pipe 125 passes through the now open squeeze valve 128 into the hole 130 in the shaft 115 without friction.

When the ejection of solid particles by centrifugal force is terminated the centrifuge is moved back to its operative position in FIG. 3 by sliding back the shaft 115. In this way the centrifuge 110 can be operated with the centrifuging drum 116 constantly rotating and pressure conditions in the drum 116 can be set as desired.

FIG. 5 shows a modified embodiment of an invertible filter centrifuge 110. In FIG. 5 corresponding parts carry the same references as in FIG. 3. In contrast with FIG. 3 the shaft 115 in the FIG. 5 embodiment is also hollow. In a bore 134 inside the hollow shaft 115 a closing element 134 in the form of a piston rod can be slid into the interior of the drum 116 in such as way that it tightly closes the insertion aperture 126 from inside the drum. A pipe 133 is formed in the closing element 135, by means of which an under or over pressure can be created inside the drum 116. The closing element 135 may be actuated hydraulically or pneumatically in a manner known per se. The end of the closing element 135 applied to the inside of the centrifuging chamber cover 124 has a seal to form a pressure-tight closure.

As illustrated, the closing element 135 is shaped as a sleeve 137 at its free front end, and the end of the filling pipe 125 projecting into the drum 116 can go inside the sleeve.

The embodiment of an invertible filter centrifuge 110 in FIG. 5 operates in the same way as previously described with reference to the FIG. 3 embodiment. In contrast with FIG. 3 however, the filling pipe 125 in the FIG. 5 embodiment need not be reciprocated and may be joined rigidly to the machine frame 112. When the drum is being filled with suspension the closing element 135 is drawn back (to the right in FIG. 5) to expose the opening of the filling pipe 125. The closing element 137 assumes the position shown in FIG. 5 while the interior of the drum is being put under pressure through the pipe 133.

A way of sealing off the cover from the filling pipe which is completely different from that explained in connection with FIGS. 3 to 5 is shown in FIG. 6. Here the filling pipe 125 is mounted cantilevered by means of rotary bearings 141 and rotatably about its longitudinal axis, in a stationary bearing block 140 which is fixed to the housing 111 but located outside it. The filling pipe 125 may be set in rotation about its longitudinal axis, which is aligned with the rotary axis of the drum 116, by a drive motor 142, preferably an electric motor, a belt 143 and a pulley 144 which is seated on the pipe 125 with resistance to torsion.

Normal shaft seals 145 seal the outside of the filling pipe 125 in the bearing block 140. The block 140 has an inlet 146 which may be connected to a pipe and through which suspension to be filtered may be introduced. From the inlet 146 the suspension passes directly into the filling pipe 125 and from there into the drum 116.

As will be seen best from the larger-scale view in FIG. 7, a bush 147 is fixed into a filling aperture 126 in the cover 124 of the drum 116, centrally and coaxially with the rotary axis of the drum, and rotates together with the drum. An elastic diaphragm 148, closed in an annular shape, is arranged near the free end of the filling pipe 125, inside a shallow recess at the end of the pipe. A pneumatic or hydraulic pressure medium may be introduced between the diaphragm and the outer wall of the filling pipe 125, located in the region of the diaphragm 148, through a pipe 149 running in the wall of the filling pipe 125. Under the pressure of the medium the diaphragm 148 turns radially outwards and lies against the inner wall of the bush 147 all the way round, so that a completely pressure-proof seal is formed between the filling pipe 125 and the cover 124 of the drum 116. As will be seen from FIG. 6, the pipe 149 leads into an annular recess 150 in the bearing block 140, into which said pressure medium for the diaphragm 148 can be introduced through a passage 151.

In FIG. 6 the diaphragm 148 is shown in the turned-out state, in which it seals off the bush 147. The diaphragm 148 is shown in the same state at the top of FIG. 7. At the bottom of FIG. 7 it is shown in its relaxed, de-pressurised state, in which it is drawn smoothly back into said recess at the end of the pipe 125 by virtue of its elasticity, so that a space is left between the sleeve 147 and the diaphragm 148 all the way round, enabling the cover 124 to be slid freely over the filling pipe 125.

The invertible filter centrifuge 160 shown in FIG. 8 comprises a housing 161 (indicated diagrammatically) sealingly enclosing the whole machine, in which a hollow shaft 163 is mounted rotatably in bearings 164, 165 on a stationary machine frame 162. A drive wheel 166 is non-rotatably connected to the end of the hollow shaft 163 projecting beyond the bearing 165, the drive wheel enabling the hollow shaft 163 to be set in rapid rotation by an electric or other motor 167 by means of a V-belt.

The hollow shaft 163 extending rigidly between the bearings 164, 165 has an axially extending wedge-shaped groove (indicated in dash-and-dot lines), in which a wedge 168 is axially displaceable. The wedge 168 is rigidly connected to a supporting shaft 169 which is displaceable inside the hollow shaft 163. The supporting shaft 169 thus rotates together with the hollow shaft 163 but is axially displaceable therein.

A cup-shaped centrifuging drum 171 is non-rotatably flange-mounted on the closed end wall 170 at the end of the hollow shaft 163 projecting beyond the bearing 164 at the left hand side of FIG. 8. It has a filtering medium 172 on its cylindrical surface.

The drum 171 is open at the side 173 opposite the closed end wall 170. The supporting shaft 169 passing freely through the closed end wall 170 of the drum 171 carries a drum base 174 which rigidly attaches a centrifuging chamber cover 176 by means of stay bolts 175, leaving a gap; in FIG. 8 the cover 176 tightly closes the centrifuging chamber of the drum 171 by lying on the edge of its opening, and is lifted free of the drum 171, together with the drum base 174, through axial sliding of the supporting shaft 169 out of the hollow shaft 163.

The drive means responsible for displacement of the supporting shaft 169 in the hollow shaft 163 and thus for the opening and closing of the centrifuging drum 171 and hence the transition between the two operating states will be described in detail later.

The procedures involved in operating the centrifuge 160 are similar to those described in connection with FIGS. 1 and 2.

As shown particularly in FIG. 9 a bush 177 is flange-mounted rigidly and non-rotatably on the end of the hollow shaft 163 supported by the bearing 165; it projects to the rear from the flange and contains an axial slot 178. A nut 179 with a radially projecting wedge 180 is rigidly connected to the rear end of the supporting shaft 169; the wedge engages in the wedge-shaped groove 178, connecting the nut 179 to the supporting shaft 169 with no relative rotation and the bush 177 to the hollow shaft 163 with no relative rotation, although the nut 179 and thus the supporting shaft 169 are axially displaceable in the bush 177.

The internal screw thread on the nut 179 is engaged by a screw spindle 181 with corresponding external thread, which is joined to a sleeve 183 non-rotatably but slightly displaceably in an axial direction by a conventional feather key connection 182. The sleeve 183 is in turn mounted rotatably in an end piece 186 fixed to the bush 177 by a flange, by means of bearings 184, 185. A disc 188 is held on the rear end of the screw spindle 181 projecting from the sleeve 183 by means of a nut 187. A disc spring 189 or the like is arranged between the rear end of the sleeve 183 and the disc 188 and biases the screw spindle 181 relative to the sleeve 183 (to the right in FIG. 9), the feather key connection 182 between the screw spindle 181 and the sleeve 183 allowing slight axial movement.

A pulley 190 is non-rotatably seated on the sleeve and is connected by V-belts to a further electric or other motor 191 (FIG. 8), which thereby rotates the sleeve 183 and thus the screw spindle 181 which is non-rotatably connected to the sleeve by the feather key 182.

The purpose of the disc spring 189, which biases the screw spindle 181 and thus via the nut 179—the supporting shaft 169 (to the right in FIG. 9), is to keep the cover 176 firmly applied to the opening edge of the centrifuging drum 171 against hydraulic pressure arising inside the drum. In simpler embodiments of the invention the screw spindle 181 could be mounted rotatably directly in the bearings 184 and 185, i.e. without the sleeve 183 being interposed. In that case the pulley 190 would be seated directly on the screw spindle 181 and the disc spring 189 used for the said purpose would be omitted.

As also illustrated, the bush 177 is mounted for rotation in its own rotary bearing 192 by means of the end piece 186 fixed to it by a flange; the rotary bearing is in turn supported on the machine frame 162 by a stand 193, so that the drive forces exerted by the pulley 190 and motor 191 can be absorbed near the bearing 192.

When the screw spindle 181 is turned in one direction or the other relative to the hollow shaft 163 and the bush 177 connected to it, in which the screw spindle 181 is mounted rotatably, by means of the pulley 190 and motor 191, then owing to the engagement of the screw spindle 181 in the nut 179 the supporting shaft 169 connected to the nut moves in one direction or the other, so that the cover 176 joined to the supporting shaft 169 carries out the required opening or closing movement.

When the centrifuge is in operation however the hollow shaft 163 carrying the centrifuging drum 171, the bush 177 rigidly connected to it and the supporting shaft 169, which telescopes axially in the hollow shaft 163 and is joined to the cover 176, rotate continuously in a certain direction. Whether the cover 176 is opened or closed depends on the relative speed of these parts particularly the supporting shaft 169, and the screw spindle 181, and mainly whether the screw spindle 181 is driven at a higher or lower speed than the supporting shaft 169. If the shaft 169 and spindle 181 rotate at the same speed there is no axial displacement of the shaft 169 in the hollow shaft 163. Only if the speed of the screw spindle 181 is higher than that of the supporting shaft 169 does the latter move in the hollow shaft 163 so as to open the cover 176. On the other hand if the speed of the screw spindle 181 is lower than that of the supporting shaft 169, or if the screw spindle 181 is driven in the opposition direction to the supporting shaft 169, the supporting shaft and with it the cover 176 move in the opposite direction, so that the cover 176 closes the centrifuging drum 171. In the preferred embodiment of the invention the supporting shaft 169 and screw spindle 181 always rotate in the same direction (except when opening and closing the drum).

The hydraulic drive previously required for opening and closing the centrifuging drum is thus replaced by a simple mechanical drive which does not have the disadvantages of the hydraulic drive caused by leakage. But this is not the only advantage of the mechanical screw spindle drive described. In contrast with the hydraulic drive, where the supporting shaft 169 is displaced by a hydraulic cylinder flange-mounted on the rear end of the hollow shaft 163, the forces required to open and close the drum and keep it closed are absorbed not by means of the main rotary bearings 164, 165 but internally by the screw spindle drive.

As the supporting shaft 169 and screw spindle 181 rotate simultaneously and in the same direction in the embodiment illustrated, and as initiation of axial displacement of the supporting shaft 169 in the hollow shaft 163 only requires these parts 169 and 181 to be rotated at different speeds in a positive and negative direction, even a relatively high absolute speed of the screw spindle 181 will only result in relatively little axial travel of the supporting shaft 169. Here the screw spindle 181 acts as a very low pitch screw (with fine thread), which means that only weak forces are needed to drive it, so the motor 191 driving the screw spindle 181 may be comparatively weak even when the supporting shaft 169 and screw spindle 181 are driven in opposite directions.

At the end of the respective lifting movement opening or closing the centrifuging drum or even if the lifting movement is sluggish, the differential speed between the hollow shaft 163 and supporting shaft 169 on the one hand and the screw spindle 181 on the other changes towards zero, so that rotation of those parts is finally synchronised. There is an automatic increase in power which—particularly when the closed state of the drum is reached—causes the centrifuging chamber cover 176 to be pressed firmly against the opening edge of the drum 171 even if the motor 191 driving the screw spindle 181 is comparatively weak.

As soon as the centrifuging drum 171 and with it the supporting shaft 169 endeavour to rotate faster than the screw spindle 181, the cover 176 of the centrifuging chamber is held automatically on the centrifuging drum 171 even if quite strong hydraulic forces are in action in the centrifuging chamber. The screw spindle closing arrangement described thus acts as a (fine-threaded) screw spindle with a self-locking action, which does not need additional radial locking. In particular, in contrast with a hydraulic closing arrangement, the screw spindle closing arrangement described does not require an additional safety device such as a centrifugal governor or the like to ensure that the centrifuging drum can open only below a certain drum speed, for in accordance with the invention the cover 176 of the centrifuging chamber is always pressed automatically and firmly onto the edge of the opening in the centrifuging drum 171 by the screw spindle drive described, so long as the screw spindle 181 rotates more slowly than the supporting shaft 169 and the parts connected to it, or in the opposite direction.

FIG. 9 shows the open condition of the centrifuging drum, with the supporting shaft 169 slid right to the left in FIG. 9 by the screw spindle 181. As illustrated, the supporting shaft 169 has a cavity 194 in front of the nut 179 joined to it; the screw spindle 181 enters this cavity when the supporting shaft is taken back (to the right in FIG. 9) during the closing movement of the centrifuging drum, with corresponding displacement of the nut 179 in the bush 177 which forms a backward extension of the hollow shaft 163.

In an embodiment of the invention which is not illustrated the screw spindle may be a spindle without a self-locking action, for example a conventional recirculating ball screw. In that case the force required to keep the centrifuging drum 171 securely closed is provided by the permanently switched-on motor 191, which drives the screw spindle 181 at a lower speed than the electric motor 167 drives the hollow shaft 163 and thus the supporting shaft 169. It is also possible to make a separate brake, which may be connected to the system, act on the motor 191 or a corresponding section of the screw spindle 181. The motor 191 may itself be used as a brake, particularly if it is a frequency-controlled electric motor.

The motor 191 does not normally initiate the opening movement of the centrifuging drum 171 until it is driving the screw spindle 181 at a speed higher than the rotating speed of the centrifuging chamber drum and with it the supporting shaft 169. So if the motor 191 is driven at constant speed during the centrifuging phase of the operation (FIG. 8), it keeps the drum securely closed so long as the drum's speed is higher than the rotating speed of the screw spindle 181. The movement opening the centrifuging drum only takes place at the transition to the solids-ejecting phase of the operation, when the speed of the centrifuging drum 171 drops below that of the screw spindle 181.

It is further possible to switch the motor 191 driving the screw spindle 181 right off each time the closed or open state of the drum is reached. Owing to the self-locking action of the screw spindle 181 in the nut 179 the screw spindle 181 and with it the motor 191 are then entrained in an idling motion by the hollow shaft 163 driven by the motor 167.

FIG. 10 shows an embodiment of the invention which has been modified further. In FIG. 10 corresponding parts carry the same references as in FIGS. 8 and 9. Whereas in the FIG. 9 embodiment the screw spindle 181 is driven in rotation by the pulley 190 and motor 191 to move the supporting shaft 169 in the hollow shaft 163, in the FIG. 10 embodiment the screw spindle 181 is non-rotatably connected to the supporting shaft 169, and the sleeve 183 in the form of a nut has internal screw thread engaged in the external thread on the screw spindle 181. The sleeve 183 is mounted axially immovably in the end piece 186 and set in rotation by the pulley 190 and motor 191, so that the screw spindle 181 and with it the supporting shaft 169 are reciprocated axially, causing the cover 176 of the centrifuging chamber to open or close in the manner already explained.

As shown in FIG. 10 the screw spindle 181 is mounted for axial sliding motion in a part 195 by a feather key 182, the part 195 being fixed to the supporting shaft 169. In this way the screw spindle 181 is non-rotatably joined to the supporting shaft 169 but can move relative to it a limited distance in an axial direction. The disc 197 against which one end of the disc spring 198 bears is held inside the supporting shaft 169 by the nut 196. The other end of the disc spring 198 lies against an internal shoulder 199 or the like in the cavity 194 of the supporting shaft 169, so that the disc spring 198, just as in the FIG. 9 embodiment, tends to bias the supporting shaft 169 in such a way that the cover 176 of the centrifuging chamber is held firmly against the edge of the opening in the drum 171 in the centrifuging phase of the operation (FIG. 8).

The FIG. 10 embodiment is to some extent a “kinematic reversal” of the FIG. 9 embodiment. The two constructions are similar in their operation and advantages.

In a further embodiment (not shown) of the “screw closure” of the drum 171 and cover 176 according to the invention, the sleeve 183 which acts as a rotated nut in FIG. 10 could be located between the stationary machine frame 162 (cf. FIG. 8) and the drum 171, if the supporting shaft 169 protruding from the hollow shaft 163 is provided with appropriate external screw thread there, in engagement with the sleeve acting as a nut. Here again the sleeve would be driven by a pulley 190 and an appropriately arranged motor 191.

The invertible filter centrifuge 200 of which a detail is shown in FIGS. 11 and 12 comprises a housing 201 in which a hollow shaft 203 is mounted rotatably by a rolling bearing 204 on a stationary machine frame 202. There is at least one more rolling bearing at the side of the machine frame 202 which is not shown, to the right of FIG. 11. The hollow shaft 203 is set in rotation by drive means (also not shown, to the right of FIG. 12).

A shaft 205 is guided for sliding motion in the hollow shaft 203, and means such as a wedge-groove connection ensure that, although the shaft 205 is displaceable relative to the hollow shaft 203, it simultaneously rotates with that hollow shaft, that is to say, is non-rotatably coupled to. Drive means (not shown) are associated with the sliding shaft 205 and reciprocate it in an axial direction as required.

In the housing 201 a cup-shaped centrifuging drum is flange-mounted on the end of the hollow shaft 203 extending beyond the bearing 204 at the left hand side of FIGS. 11 and 12, non-rotatably and cantilevered, so that a closed end wall 207 which closes the drum 206 at one side (the right side in FIG. 11) is rigidly connected to the hollow shaft 203. The drum 206 has a filtering medium 209 on its cylindrical side wall 208. It is open at the side 201 opposite the end wall 207.

The end of the sliding shaft 205 facing towards the drum 206 carries a drum base 212 arranged inside the drum, the base being rigidly connected to a drum cover 214 by stay bolts, leaving a gap in between; in FIG. 11 the cover 214 tightly closes the interior of the drum 206 by lying against the edge 211 of its opening, and in FIG. 12 it is lifted off the centrifuging drum 206 together with the drum base 212 through the shaft 205 sliding axially out of the hollow shaft 203.

A filling pipe 215 is arranged rigidly on the housing 201 at the front of the invertible filter centrifuge, at the left hand side in FIGS. 11 and 12; its function is to feed a suspension which has to be divided into its solid and liquid constituents into the interior of the centrifuging drum 206 (FIG. 11), and in the operating state of the centrifuge shown in FIG. 12 it passes into a bore 216 in the sliding shaft 205.

As will be seen from the drawing, the housing 201 is joined sealingly to the machine frame 202 behind the centrifuging drum 206. An annular seal 218 arranged in front of the rolling bearing 204 further seals off the machine frame 202 from the drum 206. In this way the housing communicating with the interior of the centrifuging drum 206 is sealingly separated from the machine frame 202.

In operation the invertible filter centrifuge first assumes the position shown in FIG. 11. The sliding shaft 205 is withdrawn into the hollow shaft 203 through appropriate control of its associated drive means, with the result that the drum base 212 fixed to the sliding shaft is near the closed end wall 207 of the centrifuging drum 206. The drum cover 214 is applied tightly to the edge of the opening in the drum 206 in the process. With the centrifuging drum rotating rapidly, e.g. at a speed of 2000 r.p.m., suspension requiring filtering is fed continuously through the filling pipe 215 into the interior of the drum 206. The liquid constituents of the suspension pass ;through the filtering medium 209 and are discharged by a screen 217. The solid particles of the suspension are retained by the filtering medium 209 as a firmly adhering filter cake.

With the drum 206 rotating slowly (e.g. at 500 r.p.m.) the sliding shaft 205 is moved forward to the left (FIG. 12) when filtration has been carried out and the supply of suspension interrupted, whereby the filter cake made of solid particles is moved outwards and ejected into the housing 201 by the drum base 212, from where it is conveyed away. When the ejection of solid particles is over the centrifuge 200 is returned to the operative position in FIG. 11 by sliding back the shaft 205.

When the centrifuge goes from the operating state in FIG. 11 to that in FIG. 12 the sliding shaft 205 passes into the interior of the centrifuging drum 206 as can be seen from FIG. 12. If the interior of the drum 206 has to be sterilised and kept free of germs for filtering sensitive products such as food or pharmaceuticals, dirty substances such as lubricants adhering to the outside of the sliding shaft 205 may pass from the side of the machine frame 202 into the internal centrifuging chamber when the drum is opened, so that the chamber is contaminated. The interior of the centrifuging drum would therefore have to be re-sterilised each time the drum was opened and re-closed. Conversely residual components of the suspension may be deposited on the outside of the sliding shaft 205 when the drum 206 is opened, and from there pass into the hollow shaft 203 mounted in the machine frame 202, which may cause malfunctioning, particularly with regard to the mobility of the shaft 205 in the shaft 203.

In order to prevent undesirable transfer of material in solid, liquid or gas form from taking place between the interior of the centrifuging drum 206, which is used to carry out the filtering process, and the machine frame 202, these two chambers are separated from each other by a partition wall. In the embodiment in FIGS. 11 and 12 the partition wall is a normally disc-shaped, substantially cylindrical bellows-type diaphragm 221, the outer edge of which is joined to the outer edge of the end wall 207. An inner edge of the diaphragm 221, surrounding a central aperture, is joined to the sliding shaft 205 in the immediate vicinity of the drum base 212. In its normal (slackened) state shown in FIG. 11, i.e. when the drum 206 is closed, the bellows-type diaphragm has a substantially flat shape, with concentric corrugations in the plane of the diaphragm. When the drum 206 is opened, i.e. when the drum base 212 is pushed forward by the sliding shaft 205 relative to the closed end wall 207 (FIG. 12), the diaphragm 221 expands into a conical configuration with its corrugations smoothed as in FIG. 11. The diaphragm 221 is made of a flexible material which can stretch and tighten elastically, such as rubber.

As will be seen particularly from FIG. 12, the bellows-type diaphragm 221 forms a sealing partition wall between the sliding shaft 205 carrying the drum base 212 and the interior of the centrifuging drum receiving the suspension; hence the interior of the drum is separated from the side of the machine frame 202 so as to prevent any exchange of substances.

The invertible filter centrifuge shown in FIGS. 13 and 14 differs from the invertible filter centrifuge according to FIGS. 11 and 12 only in the fact that normal bellows 222 are provided as the partition wall in FIGS. 13 and 14; one side of the bellows is joined to the closed end wall 207 and the other side to the drum base 212, the drum base 212 having an appropriate protuberance 223 to receive the collapsed bellows (FIG. 13). When the drum 206 is open (FIG. 14) the expanded bellows separate its interior from the sliding shaft 205 in the same way as the bellow-type diaphragm 221 in FIGS. 11 and 12.

A differential pressure monitoring instrument may be associated with the partition wall in the form of a bellows-type diaphragm 221 or bellows 222, to monitor the wall for leakages. As illustrated in the drawing an above-atmospheric or low pressure P1 is produced in a closed chamber 225 by means of a pump 224. As shown particularly by FIGS. 12 and 14, the chamber 225 is connected by a pipe 226 to the side of the partition wall (diaphragm 221 or bellows 222) facing towards the machine frame 202 and sliding shaft 205, so the pressure P1 also prevails in that chamber. A pressure P2, e.g. atmospheric pressure, prevails at the opposite side of the partition wall facing the interior of the drum 206. A measuring instrument 227 is used to monitor the pressure difference P2−P1. As soon as the reading differs from a predetermined value a signal is triggered and/or the invertible filter centrifuge is stopped, because this change in the differential pressure indicates a leakage in the partition wall (diaphragm 221 or bellows 222).

In the embodiments described the bellows-type diaphragm 221 acting as a partition wall and the bellows 222 serving the same purpose are in the form of a flexible, expansible member. Expansibility is not absolutely essential, for example when the wall is in the form of a flexible, non-expansible cloth which collapses or folds up when the drum is closed.

The corrugations or folds in the diaphragm 221 or bellows 222 may also be omitted. These members may be smooth if the requisite expansibility is obtained from the elastic properties of the material from which they are made. Hence a shallow diaphragm which is more or less flat even when inoperative may be used instead of a bellows-type one.

The invertible filter centrifuge 230 shown in FIG. 15, for processing chemical substances of different weights, in known manner comprises a drum 234 which is mounted rotatably in a machine housing 232 by means of a shaft 233 and which can be driven by a motor 235 and closed by an axially displaceable cover 236. A drum base 238 is rigidly connected to the cover 236 by struts 237 and therefore moves together with the cover 236. A large area of the cylindrical wall of the drum 234 is formed by a filtering medium 239. The housing 232 comprises a front part 232a and a rear part 232b.

In the illustrated operating position of the centrifuge 230, substance to be filtered, namely a suspension consisting of solids and liquids, is put into the drum 234 through a filling pipe 240. Rotation of the drum and filtering medium 239 causes the solid to collect on the inside of the filtering medium in the form of a so-called cake, while the liquid, after passing through the filtering medium 239, reaches the outside of the drum 234 and is collected through a filtrate drain 231. In order to release the cake from the filtering medium 239 when the filtering process is over, the cover 236 and with it the drum base 238 in FIG. 15 are moved to the left, whereby the cake reaches the front part 232a of the housing 232, is ejected and drops into a removable container 242. When the cake has been ejected the cover 236 is re-closed so that the centrifuge returns to its initial operative position and suspension to be filtered can be fed into the drum 234 again through the filling pipe 240.

The arrangement described, including the housing 232, drum 234 and drive motor 235, is rigid in itself and is mounted to rotate about a horizontal pivot 243, i.e. in a vertical plane. The pivot 243 is arranged on a resilient buffering element 244 which in turn rests on a stationary substructure 246 fixed to the ground 245. The resilient buffering element 244 may e.g. be a normal rubber-metal member, and its function is to absorb and damp vibrations which may occur through the rotation of the drum 234. The pivot 243 may be omitted if the buffering element 244 itself allows the arrangement to rotate in a vertical plane. A force-measuring element 248, e.g. a load cell, which is known per se and loaded in tension or compression, is arranged between the housing 232 and another stationary substructure 247. Thus the whole arrangement acts like a kind of beam balance: the side of the centrifuge 230 above the buffering element 244 to the left of the horizontal pivot 243 is loaded by the substance introduced into the drum 234 through the filling pipe 240, and the force-measuring element 248 to the right of the pivot 243 is thereby affected accordingly. The weight thus measured may be indicated on a scale (not shown).

In order not to disrupt the weighing process the container 242, which receives the cake and is fixed to the ground 245, has to be joined to the housing 232 by a slightly flexible, gas-proof coupling means 249, e.g. in the form of bellows, so that the left hand side of the arrangement can rotate around the horizontal hinge pin 243 as freely as possible.

Processing of the chemical substance introduced, i.e. filtering the substance, is carried out at a certain pressure (over pressure or under pressure). To obtain an over pressure an e.g. inert gas but possibly air may be let into the front part 232a of the housing 232, which is separated from the rear part 232b of the housing in gas-tight manner by a partition wall 250. Owing to the flexible coupling means 249 between the movable housing 232 and the stationary container 242, the gas pressure prevailing in the machine gives rise to a disruptive force P₁ in the front part 232a of the housing 232, directed upwardly in the case of an over pressure or downwardly in the case of an under pressure; this falsifies the weighing process, as it counteracts the downwardly directed weight of the substance placed in the drum or apparently increases its weight. The disruptive force P₁ therefore has to be compensated to obtain accurate weighing.

For this purpose a pressure sensor 251 is provided on the housing 232 of the centrifuge 230 to sense the gas pressure inside the machine (housing section 232a). The force sensor 248 of the arrangement is connected by an electric lead 252 to a weight indicator 253 comprising a pointer 255 moving over a scale 254. The pressure sensor 250 is also connected to the weight indicator 253, by a lead 256. The indicator 253 contains an electrical means known per se, whereby the position of the pointer 255 is suitably corrected dependent on the gas pressure prevailing in the centrifuge 230, so that the pointer 255 always indicates the true weight of the chemical substance placed in the machine or the degree to which the filter cake has dried. Fluctuating gas pressures in the centrifuge 230 can also be compensated quickly with the FIG. 15 arrangement.

A further lead 257 connects the weight indicator 253 in the conventional way to a valve 258 controlling the filling pipe 240, so that when a certain filling weight is reached the valve 258 is closed and the intake of more substance into the drum 234 can be prevented.

The invertible filter centrifuge 260 shown in FIGS. 16 and 17 comprises a diagrammatically indicated machine housing 261, which encloses the drive section of the centrifuge (to the right of each of the figures and not visible) and in which a hollow shaft 263 is supported rotatably in bearings 264, 265 on a stationary machine frame 262. The hollow shaft 263 can be set in rapid rotation by a motor (not shown). It extends beyond a partition wall 266 which closes the front of the machine housing 261 and contains an axially extending, wedge-shaped groove (also not shown) in which a wedge 269 is axially displaceable. The wedge is rigidly connected to a shaft 270 displaceable inside the hollow shaft 263. The shaft 270 rotates together with the hollow shaft 263 but is axially displaceable therein.

The closed end wall 272 of a cup-shaped centrifuging drum 271 is mounted rotatably by a flange on the end of the hollow shaft 263 projecting beyond the partition wall 266. The cylindrical side wall of the drum 271 has a filtering medium 273 of large area. The side of the drum 271 opposite the end wall 272 is open.

The end of the shaft 270 facing towards the drum 271, which passes freely through the partition wall 266 and the closed end wall of the drum 271, carries a drum base 274 inside the drum 271; the base rigidly carries a centrifuging chamber cover 276 by means of stay bolts 275, so as to leave a gap, and the cover seals the interior of the centrifuging drum 271 in FIG. 16 by lying against the edge 277 of its opening.

The machine housing 261 is adjoined by two housing chambers 278 and 279 in the region of the centrifuging drum 271, the chambers being separated from each other by an annular wall 280 near the edge 277 of the opening in the drum 271. The first chamber 278 is used to drain a filtrate which has passed through the filtering medium 273 of the drum 271, and has an outlet 267 for that purpose. When the drum base 274 has been extended a filter cake deposited on the filtering medium can be discharged through an outlet 268 in the second housing chamber 279.

A rigid, possibly removable filling pipe 281 is arranged at the front of the centrifuge (at the left in the drawing) and is used to feed a suspension which has to be divided into its solid and liquid components into the interior of the centrifuging drum 271 (FIG. 16).

During the centrifuging operation the centrifuge 260 adopts the position shown in FIG. 16. The displaceable shaft 270 is drawn back into the hollow shaft 263, and hence the drum base 274 joined to the shaft 270 is near the end wall 272 of the drum 271. The cover 276 of the centrifuging chamber has been applied sealingly to the edge 277 of the opening in the drum 271. The suspension to be filtered is introduced continuously through the filling pipe 281 with the drum 271 rotating. The liquid components of the suspension pass through the filtering medium 273 into the first housing chamber 2787 as the filtrate, and from there are guided by a baffle plate 282 into a drain pipe 283 connected to the outlet 267. The solid particles of the suspension are retained by the filtering medium 273 in the form of a filter cake.

The housing chamber 278 is enclosed by a self-contained, inherently rigid, annular, preferably approximately circular housing section 284 (the “filtrate housing section”), one opening edge of which is applied to the partition wall 266 of the machine housing 261 with a seal (not shown) interposed, while the other opening edge formed by the end wall 280 is contiguous with the outside of the opening edge 277 of the drum 271, again with a seal (not shown) interposed. The outlet 267 is formed at the underside of the first housing section 284 and is connected sealingly to the drain pipe 283, again with seals (not shown) interposed. As will be seen from FIG. 17 the housing section 284 is pivotable about a vertical shaft 285, so that it can be transferred from a closed state enclosing the centrifuging drum 271 to an open state.

FIG. 17 shows the partly open state of the centrifuge 260. The housing section 284 can be rotated still further away from the centrifuging drum 271, so that the drum is accessible e.g. for cleaning—completely unimpeded by the housing section 284. The same naturally applies to the housing section 278 itself. As shown in FIG. 17 the rotary shaft 285 is supported in hinge-like manner by projecting parts 286, 287 arranged rigidly on the housing section 284 and the housing 261 (partition wall 266) respectively.

Like the first housing chamber 278 the adjoining second housing chamber 279 is surrounded by an inherently rigid, cup-shaped, substantially cylindrical housing section 288 (the “solids housing section”). The section 288 has a closed end wall 289 with a passage for the filling pipe 281 and an opening edge opposite the end wall, applied sealingly to the first housing section 284. Like the first section 284 the second section 288 is pivotable about a vertical shaft 290 (FIG. 17) extending through projecting parts 291, 292 on the section 288 and the machine housing 261 (partition wall 266) respectively. The housing section 288 can also be rotated beyond the open position shown in FIG. 17 to allow completely unimpeded access to the centrifuging drum 271 and housing section 288. The underside of the section 288 has an outlet 268 which is connected to the drain pipe 293 sealingly (in a manner not shown).

It is also possible to put only the second housing section 288 in the open state and to leave the first section 284 closed. In that case the section 288 could for example be cleaned (of solids) or the filtering medium 273 and/or the seals on the centrifuging drum 271 or the drum base 274 could be changed.

The outlets 267, 268 in the housing sections 284, 288 are sealed in such a way that rotation of the sections 284, 288 is not impeded, for example using sliding seals.

The housing sections 284, 288 are transferred from the closed to the open state (FIG. 17) preferably while the cover 276 of the centrifuging chamber is closed; only then is the cover lifted off the drum 271, when the sections 284, 288 have rotated a suitable distance away. Alternatively however the sections 284, 288 may basically be dimensioned so that they can be transferred from the closed to the open state with the cover 276 of the centrifuging chamber lifted off.

In the illustrated form of the housing sections 284, 288 the second section 288 is transferred from the closed to the open condition first and the first section 284 afterwards. Conversely the first section 284 is sealingly applied to the machine housing 261 first, whereupon the second section 288 is sealingly connected to the first section 284 by rotation (FIG. 16). Before the second section 288 is rotated into the open position the filling pipe 281, which can be taken out for this purpose, is removed.

Alternatively the filling pipe 281 may be fixed to the second housing section 288, in such a way that it is released from its inlet aperture in the cover 276 of the centrifuging chamber when the section 288 is opened, and is rotated away together with the section 288. In that case a suspension feed pipe connected to the filling pipe 276 outside the section 288 has to be removed, or that feed pipe has to be flexible.

As shown in FIG. 16 the filtrate housing 284 and the solids housing 288 are interconnected by a “gas compensation pipe” 294 running outside the housing and containing a check valve 295 in the case illustrated. There is no such check valve 295 in known invertible filter centrifuges so, if pressure differences of the above type occur during normal operation with the centrifuge, pressure compensation can take place between filtrate housing section 284 and solids housing section 288, in both directions. As there is no check valve 295 foreign particles can naturally pass from one housing into the other. When an over pressure is generated in one of the housings 284 or 288 as described above, the check valve 295 is provided in the gas compensation pipe 294 and kept closed while that pressure is being generated, in order to avoid undesirable transfer of foreign substances.

The situation is illustrated again in FIGS. 18 and 19 for clarification, diagrammatically and clearly arranged. FIG. 18 shows the annular gap 296 between the annular wall 280 and the edge of the centrifuging drum 271 corresponding to the circular region X in FIG. 16. Under the operating conditions in FIG. 16, i.e. with the centrifuging drum 271 closed, a flow of gas directed into the filtrate chamber 278 is generated in the direction of the arrow I; air may for example act as the blocking medium. If solids are conversely being ejected by the advancing drum base 274, a stream of gaseous blocking medium is created through the annular gap 296 in the direction of the arrow II. The situation is similar for an annular gap 296 with two sealing strips 297 surrounding the drum 271 in an annular shape as shown in FIG. 19.

The problems described above can be avoided if a flow of blocking medium is created in the annular gap 296. The flow of gaseous blocking medium in the annular gap 296 may be produced in the desired direction either by over pressure or by under pressure in one of the chambers forming the filtrate housing and solids housing. Combinations of over and under pressure in these chambers are also possible.

Instead of the gaseous blocking medium being introduced into either the filtrate housing 278 or the solids housing 279 with the formation of a corresponding pressure drop, it may be fed directly to the annular gap 296 and from there diverted directly into the housing chamber in question. It is particularly beneficial for the gas supplied to be passed into both the filtrate housing 278 and the solids housing 279 as shown in FIG. 18A, thereby obtaining a dual sealing action against the transfer of foreign particles. In this connection FIG. 18A diagrammatically shows two gas supply pipes 298, 299 in the partition wall 280. In practice many such pipes 298, 299 extend radially within the partition wall 280 e.g. from a common annular pipe and discharge into the annular gap 296, where they generate the desired flows of blocking gas in directions I and II. The annular pipe is connected to a gas source (a pump) (not shown).

In the modified embodiment in FIG. 19A only one pipe 300 is provided in the partition wall 280 instead of the two pipes 298, 299; it may again be thought of as a radial branch from an annular pipe surrounding the drum 271 and. connected to a pump. In this case the two flows of blocking medium in directions I and II go in opposite directions from a single opening.

The annular gap 296 in FIG. 19A again contains two annular sealing strips 297 surrounding the drum 271 and fixed in the partition wall 280. The blocking medium is introduced through the pipe 300 between the strips 297. It is also possible not to introduce the gaseous blocking medium into the annular gap 296 in both directions I and II as in FIGS. 18A and 19A, but instead to guide it either only in direction I or only in direction II according to the operating state of the centrifuge.

The flows of gas in directions I and II shown in FIGS. 18A and 19A can be produced either by over pressure in the pipes 298, 299, 300 or by under pressure in the respective chambers receiving the flows, namely either the filtrate chamber 298 machine housing 302, which can be set in rapid rotation by a motor (not or the solids chamber 279.

The invertible filter centrifuge 301 illustrated in FIG. 20 comprises a rotatably mounted hollow shaft 303 in a shown). The hollow shaft 303 extends beyond a partition wall 304 which closes the machine housing 302 at the front, and contains an axially extending wedge-shaped groove (also not shown), in which a wedge 305 is axially displaceable. The wedge 305 is rigidly connected to a shaft 306 which is displaceable inside the hollow shaft 303 and which thus rotates together with that shaft 303 but is axially displaceable therein.

A cup-shaped centrifuging drum 307 is non-rotatably flange-mounted on the end of the hollow shaft 303 projecting beyond the partition wall 304. The cylindrical side wall of the drum 307 contains radial passages. The drum 307 is closed by an end wall 308 at one side and open at the side opposite the wall 308. Inside the drum 307 a drum base 311 is joined rigidly to the displaceable shaft 306 passing freely through the end wall 308.

The closed centrifuging drum 307 (FIG. 20) revolves in a certain section of the machine housing 302. Liquid (filtrate) expressed from the drum 307 passes into a drain pipe 314 which is flexibly connected to the machine housing 302 by bellows 315. The drain pipe 314 may be closed by a check valve 316. Discharge and ejection of the solids separated from the liquid take place in another section of the machine housing 302, which accommodates the drawn-out cover 313 of the centrifuging chamber. This section of the housing 302 is connected flexibly to a solids dryer 310 by bellows 317. The dryer 310 can be sealed off from the housing 302 by a check valve 318. In the embodiment illustrated a de-agglomerator 319 is arranged between the housing 302 and the dryer 310 (above the valve 318) and is used for preliminary size reduction of the solids 320 passing into the dryer. The de-agglomerator is not absolutely essential.

The actual solids dryer 310 receiving the solids 320 ejected and possibly reduced in size includes a container 321 which may be heated by an e.g. electrical heater 322. The heat is transmitted to the solids 320 by thermal contact, thereby subjecting the solids 320 to drying.

The container 321 may be closed at the underside by a rotating flap 323 with perforations 324 extending right through it. When the flap 323 is open the dried solids 320 pass into a further container 325, the outlet of which may optionally be sealed by a check valve 326. The outlet of the container 325 may be connected to a product-receiving vessel into which the fully dried solids 320 are passed when the valve 326 is open. The container 325 has an inlet connection 327 for drying gas, which flows through the solids 320 in the container 321 via the perforations 324 in the flap 323 and is discharged through a pipe 328.

The centrifuge 301 is further provided with a filling pipe 329, used to feed a suspension, which has to be divided into its solid and liquid constituents, into the interior of the centrifuging drum 307 (FIG. 20); in the operative state, with the cover 313 lifted off and the drum base 311 drawn out, the pipe 329 passes into a bore 331 in the sliding shaft 306, and displacement of the shaft 306 and hence opening and closing of the drum 307 are effected by drive motors (not shown, to the right of the drawing), e.g. hydraulically,

In the centrifuging operation the invertible filter centrifuge 301 adopts the position shown in FIG. 20. The sliding shaft 306 is drawn back into the hollow shaft 303. The cover 313 of the centrifuging chamber closes the open end of the centrifuging drum 307. The suspension which has to be filtered is supplied continuously through the filling pipe 329 with the drum 307 in rapid rotation. The liquid constituents of the suspension pass through the filtering medium 309 in the surface of the drum into the machine housing 302 as the filtrate, and are passed from the housing 302 into the discharge pipe 314. The solid particles of the suspension are retained by the filtering medium 309 in the form of a filter cake.

With the centrifuging drum 307 still rotating—usually more slowly—and with the supply of suspension through the filling pipe 329 cut off by a valve 330, the shaft 306 is displaced (to the left), causing the filter cake to be moved outwards and ejected. The solid particles enter the container 321 of the solids dryer 310 with the check valve 318 open—possibly after passing through the de-agglomerator 319—and the solids 320 are further de-humidified and dried in the dryer in the manner already indicated above.

When the ejection of solids 320 is over, the centrifuge 301 is returned to the operating position in FIG. 20 by sliding back the shaft 306. In this way the centrifuge 301 can be operated with the drum 307 rotating continuously.

The arrangement described, including the machine housing 302 and centrifuging drum 307, is inherently rigid and mounted for rotational movement about a horizontal rotary pivot 332. The pivot 332 is arranged on a resilient buffering element 333, which in turn rests on a stationary substructure 334 fixed e.g. to the ground. A force-measuring member 335 is arranged between the machine housing 302 and the substructure 334, some distance away from the pivot 332. The whole arrangement thus acts as a kind of beam balance: the side of the centrifuge 301 to the left of the pivot 332 is loaded by the substance introduced into the drum 207 through the filling pipe 329, and hence the force-measuring member 335 to the right of the pivot 332 is affected accordingly. The weight thus measured may be used to check the amount of material in the drum 307. The force-measuring member 335 may also be utilised for sensing the degree of de-humidification of the solids, as ejection of liquid leads to a loss of weight.

The above-mentioned bellows 315, 317 on the filtrate discharge pipe 314 and solids dryer 310 respectively prevent any disruption of the weighing process, as they uncouple the “beam balance” in that respect from the stationary parts 314 and 310. An uncoupling means of this type (not visible in the drawing) is of course also provided in the filling pipe 329, e.g. in the form of a tube similarly shaped as bellows, located outside the machine housing 301 and forming part of the filling pipe 329.

As illustrated, the filling pipe 329 is joined to a pipe 341 through which a gas can be let into the interior of the centrifuging drum 307. For this purpose the free end of the filling pipe 329 is inserted in the drum 307 in gas-tight manner by means of a rotatable seal 342. In this way a gas at a relatively high pressure can be passed into the interior of the drum 307, serving to blow through the still moisture-filled capillaries of the solids (filter cake) clinging to the filtering medium 309. A drying gas pre-heated to a certain temperature may further be introduced through the pipe 341 into the closed drum 307, then flow through the filter cake and dry the solids. The waste gas which has passed through the solids is discharged through an outlet connection 343 and a pipe 344. In this way purely mechanical centrifugal drying may be combined with drying by heat convection by means of a flowing gas. Compression of the filter cake with high-pressure gas is also possible, to clear its capillaries

The pipe 341, containing a check valve 345, is connected at the end opposite the filling pipe 329 to an apparatus 346 for supplying the gases which serve the given purposes. In addition to a gas source the apparatus 346 particularly contains (in known manner and not shown) a compressor and heaters to bring the gas fed in through the filling pipe 329 to the desired pressure and temperature. The apparatus 346 also serves to reprocess the waste gas supplied through the pipe 344. For this purpose it particularly contains de-humidifying means (condensers), filtering means, gas-washing means, adsorption means and the like in known manner. The reprocessed gas is fed back to the invertible filter centrifuge 301 through the pipe 341.

Drying gas from the apparatus 346 may be inserted through a pipe 347, connected to the inlet connection 327 on the container and containing a valve 348, into the solids dryer 310, where it passes through and dries the solids 320 and is discharged through the pipe 328. As shown in the drawing, the pipe 328 carries the moisture-laden waste gas back to the apparatus 346, where it is reprocessed and recycled to the solids dryer 310 through the pipe 347.

Downstream of the solids dryer 310 the pipe 328 contains a filter 351 for separating noxious matter. The filter 351 can be backwashed through a pipe 352 with a valve 353, which branches off the pipe 341. A valve 354 provided in the pipe 328 is closed during the backwashing.

A pipe 356 with a valve 357, which contains a vacuum pump 358 (a suction pump) and leads back to the apparatus 346, branches off from the pipe 328, which contains a further valve 355 near the apparatus 346, so that gas drawn off by the vacuum pump 358 can also be reprocessed in the apparatus. A vacuum (under pressure) can thus be produced in the container 321 of the solids dryer 310 with the valves 353, 355 closed and the valves 354, 357 open; this is beneficial for de-humidifying the solids 320 in the container 321. The valve 348 in the pipe 347 is normally closed in this case. It may however be beneficial to open the valve 348 slightly, so that a small volume of drying gas comes in through the pipe 347 and flows through the solids 320 as a so-called “creeping gas”. The creeping gas improves the entrainment and discharge of the vapour formed under vacuum through the pipe 328.

With the aid of the vacuum pump 358 the solids 320 in the container 321 can be subjected to alternating pressure stress through the pipe 328, leading to their de-agglomeration or reduction in size. This is caused by the vapour pressure which forms in the agglomerated solids 320. To carry out de-agglomeration by alternating pressure the valve 354 in the pipe 328 and the valve 348 in the pipe 347 are alternately opened and closed under the vacuum conditions described above. The valves 354 and 348 are connected to appropriate control means 361 and 362 respectively for this purpose.

The installation shown in the drawing contains further sensors apart from the already mentioned sensor designed as a force-measuring member 335 and serving e.g. to establish the degree of de-humidification: in the pipe 347 there is a sensor 363 used to measure the pressure and/or temperature of the drying gas supplied through that pipe. Other sensors 364 arranged in the solids dryer 310 serve to determine the temperature and/or residual moisture of the solids 320 or the temperature and/or moisture content of the waste gas in the dryer 310. A sensor 365 in the liquid discharge pipe 314 is used to determine the flow rate and/or pH of the filtrate. A sensor 366 on the shaft 303 of the invertible filter centrifuge is used to measure the rotary speed of the drum 307. The temperature of the waste gas and the quantity of moisture contained in it can be established by a sensor 367 in the waste gas pipe 344. A sensor 368 in the pipe 341 serves to determine the pressure and humidity of the gas fed to the centrifuging drum 307 through the filling pipe 329. And finally a sensor 369 for sensing the flow rate and/or temperature of the suspension supplied is arranged in the filling pipe 329. All these sensors, and other ones if required, are connected to a control means 371 by pipes which are not specifically shown in the drawing for the sake of clarity, and the control means is connected to the apparatus 346 for supplying and reprocessing the necessary gases. The control means 371 can be programmed in known manner so that the operation of the arrangement described can be controlled automatically in a self-regulating manner, and particularly so that the duration and intensity of the individual drying processes, e.g. the duration of the centrifuging process or the time taken to feed drying gas through the pipe 347, is determined accordingly. Details of these control processes will be explained below.

Mechanical, sealed separation of the invertible filter centrifuge 301 from the solids dryer 310 by the closing element formed by the check valve 318 is important to the mode of operation of the described arrangement for separating liquids and solids then de-humidifying and drying the solids. Although the invertible filter centrifuge 301 and solids dryer 310 form a unit or complete system, both the invertible filter centrifuge and the dryer are each a separate, closed system.

None of the measures taken to dry the solids in the solids dryer 310 adversely affect the processes simultaneously taking place in the invertible filter centrifuge 301. The drying processes in the solids dryer 310 may include not only the already-mentioned contact drying (heater 322), convection drying (drying gas supplied through pipe 347) and vacuum drying (vacuum pump 358) but also drying in a fluidised or flying bed, produced in the container 321 of the solids dryer 310 by drying gas supplied at an appropriately high pressure through the pipe 347. Owing to the separation of the two systems by the check valve 318 the processes in the solids dryer 310 do not moreover affect control of the filling of the centrifuging drum 307 e.g. by gravimetric or radiometric methods (g rays) or a stream of gas possibly introduced into the machine housing 301 for sealing purposes.

If the gases fed in through the pipes 341 and 347 are returned through the pipes 344 and 328 respectively and re-used after treatment in the apparatus 346 as described and illustrated, this provides a particularly favourable opportunity to share the gases in question effectively and in energy-saving manner, i.e. economically, between the two systems of the invertible filter centrifuge 301 and the solids dryer 310.

An example of such sharing of the gas flow will now be given; it is divided into two stages or processing steps both in the invertible filter centrifuge 301 and in the solids dryer 310.

In a first stage in the invertible filter centrifuge 301 the steps of filling, intermediate centrifuging, washing and final centrifuging, possibly centrifuging under pressure, are carried out. No gas is needed for any of the steps in this stage except centrifuging under pressure, and only a small quantity of gas is required even for that step.

At the second stage gas is passed through the solids (the filter cake) in the invertible filter centrifuge 301 for the purpose of convention drying. The effect of the drying depends on both the condition of the gas (humidity, temperature) and the volume of gas and its flow rate. A relatively large volume of gas is required at this stage.

In the solids dryer 310 the conditions in respect of the above-mentioned processes in the invertible filter centrifuge 301 are directly reversed. At a first stage a large volume of gas flows through the solids 320 in the container 321, even if additional contact drying is applied by the heater 322. If final drying is then carried out in the solds dryer 310 at a second stage, theoretically no gas flow is needed. As already mentioned though, it has been found advantageous to have a small volume of gas, a so-called “creeping gas”, flowing through the solids 320 as this facilitates movement of the last remaining liquid evaporated by the vacuum. However virtually no gas or only an extremely small quantity is required at this second stage.

Ways of dividing the whole de-humidifying and drying process and subdividing it into the above-mentioned stages which are favourable in terms of energy can be determined by tests, with process engineering aspects and cost parameters being taken into account. But the division thus obtained is often valid only for a certain moment in the whole process. Many products are not homogeneously distributed in a suspension or have changing particle sizes e.g. because of a build-up of crystallisation or breakage of particles. Furthermore the product is changed frequently in installations of the type described, and optimum setting parameters may e.g. have to be determined afresh each time.

Optimum division into the individual drying stages both in the invertible filter centrifuge 301 and in the solids dryer 310 is obtained by a self-controlling process in the sense of a regulating circuit as previously described, with a plurality of sensors and the control means 371 connected to the apparatus supplying the drying gas being used, again as already stated. The shortest possible total time for complete separation of liquid and solids, including de-humidifying and drying the solids, can thereby be obtained, if the de-humidifying and drying processes in the invertible filter centrifuge 301 and the solids dryer 310 are continuously monitored by the sensors responding to temperature, humidity, weight, flow rate, pressure etc. The measured values are then constantly compared to the target values to be reached for dehumidification and drying in both the invertible filter centrifuge 301 and the solids dryer 310. The target values are themselves based on known or acquired data relevant to economic de-humidification and drying.

If the stipulated target values are reached the drying process in the solids dryer 310 is terminated and that in the invertible filter centrifuge 301 is simultaneously interrupted. The solids dryer 310 is emptied by opening the flap 323 and fresh, pre-dried solids are transferred to it from the invertible filter centrifuge 301.

If the drying process in the solids dryer 310 turns out not to reach the target values when the invertible filter centrifuge 301 has already reached its own target, the drying result in the invertible filter centrifuge 301 may be improved e.g. by increasing the throughput of gas in the centrifuging drum 307, raising the temperature of the drying gas etc. The speed of the centrifuge may likewise possibly be raised to improve mechanical drying (draining). In this way the product passed into the solids dryer may be more intensively pre-dried and can then be dried in the solids dryer in a shorter time. The operating times of invertible filter centrifuge and solids dryer are thereby harmoniously co-ordinated. Conversely the operating parameters for the solids dryer 310 may be suitably re-adjusted if the solids dryer is found to reach its target values before the invertible filter centrifuge 301. It is also possible to adjust the operating parameters of both the invertible filter centrifuge 301 and the solids dryer 310 in order to obtain harmonious or synergetic interplay between these two units.

With the procedure proposed here the systems formed by the invertible filter centrifuge 301 and the solids dryer 310 are optimised even with e.g. a minimum total operating time targeted; the proportion of the de-humidification obtained mechanically by centrifuging and the proportion obtained thermally with drying gas may vary considerably from batch to batch in terms of the time taken and the result.

Alternatively the operation of the installation comprising the invertible filter centrifuge 301 and the solids dryer 310 may basically be controlled by stipulating fixed times, e.g. determined for each product by testing, and by interrupting the de-humidifying and drying process in the invertible filter centrifuge 301 and solids dryer 310 when the respective times have elapsed. It is possible e.g. to divide the de-humidifying and drying times in the invertible filter centrifuge and solids dryer in a 1:1 ratio or in other ratios, according to the operating conditions obtaining and the target values to be reached, while maintaining the most economic and rational possible mode of operation.

FIGS. 21 to 23 finally show other forms of invertible filter centrifuges with optimum weighing.

The invertible filter centrifuge 401 shown diagrammatically in FIG. 21, for processing suspensions of different weights, in known manner comprises a drum 404 which is mounted rotatably on a shaft 403 in a machine housing 402, can be rotated by a motor 405 and can be closed by an axially displaceable cover 406. A drum base 408 is rigidly connected to the cover 406 by struts 407 and is displaced together with the cover 406.

The housing 402 comprises a front section 402a and a rear section 402b which are separated from each other in gas-tight manner by a partition wall 422.

In the operating position of the centrifuge 401 illustrated substance to be filtered, namely a suspension comprising solids and liquid, is fed into the drum 404 through a filling pipe 411. Rotation of the drum 404 causes the solids to collect on the inside of a filtering medium 409, which largely forms the cylindrical wall of the drum 404, in the form of a so-called “cake”, while the liquid passes through the filtering medium 409, reaches the outside of the drum and is collected by a filtrate drain 412. To discharge the “cake” when filtering is over, the supply of suspension is cut off then the cover 406 and with it the drum base 408 are slid to the left in FIG. 21, so that the “cake” is pushed out of the drum 404 by the base. Further rotation of the drum 404 throws the cake into the front section 402a of the housing, and it drops into a removable container 413. When the cake has been thrown out the cover 406 is closed again, so that the initial operating position is resumed and suspension to be filtered can be fed into the drum 404 afresh through the filling pipe 411.

The arrangement described, including the housing 402, drum 404, drive motor 405 and filling pipe 4311, is inherently rigid and mounted for rotating movement about a horizontal pivot 414, i.e. in a vertical plane. The pivot 414 is in turn arranged on resilient buffering elements 415 resting on a stationary substructure 417 which is fixed to the ground 416. The buffering elements 415 may for example be normal rubber-metal elements, and are used to absorb and damp vibrations which may be caused by rotation of the drum 404. The pivot 414 may be physically omitted if the buffering elements 415 themselves allow the arrangement to rotate in a vertical plane.

A force-measuring member 419 which is known per se and may be loaded in tension or compression, for example a load cell, is arranged between the housing 402 and another stationary substructure 418. Hence the whole arrangement works like a kind of beam balance: the suspension put into the drum 404 through the filling pipe 411 loads the side of the centrifuge 401 to the left of the horizontal pivot 414 and thereby has a corresponding effect on the force-measuring member 419 to the right of the pivot 414. The member 419 is connected by an electric lead 434 to a measurement indicator 435 calibrated e.g. in weight units or units indicating the filling state, comprising a pointer 437 moving over a scale 436.

The centrifuge 401 operating like a beam balance may be uncoupled from its environment to avoid measuring errors, by connecting the machine housing 402 to the container 413 by a flexible, gas-tight coupling means 421 such as bellows, so that the left hand side of the arrangement can rotate freely about the pivot 414. A pipe 410 for feeding in the suspension, connected to the filling pipe 411, is suitably provided with a flexible piece of pipe 430, similarly to allow the arrangement to rotate about the pivot 414 without malfunctioning.

In certain applications it is desirable to carry out the filtering operation in the drum 404 at over pressure or under pressure. In the embodiment illustrated such pressure is generated in the interior of the drum 404 enclosed by the filtering medium 409 through the pipe 410 and the filling pipe 411. The pressure naturally gives rise to a force P₁ dependent on the cross-section of the filling pipe 411; owing to the horizontal intake of pressure in FIG. 21 the force is also exerted horizontally in the direction of the double arrow 440, and owing to the distance a between the filling pipe 411 and the hinge pin 414 it generates a corresponding torque P₁×a, which acts in a clockwise or anti-clockwise direction depending on whether the pressure is above-atmospheric or low. The force P₁ produces a torque P₂×b in the force-measuring member 419 as a reaction at the opposite side of the pivot 414, the relationship being

P₁×a=P₂×b (1)

In this formula the force P₂ acts as a disruptive force which falsifies the weighing. It follows from the above formula that

P₂=P₁×a/b (2)

So the disruptive force P₂ is naturally an immediate function of the force P₁ which is directly dependent on the above-atmospheric or low pressure introduced, and the effect of the disruptive force P₂ has to be eliminated.

In the embodiment shown in FIG. 22 the filling pipe 411 is rigidly connected to an elbow 441 at the place where it enters the machine housing 402, and the elbow is in turn connected to the flexible piece 430 of the pipe 410. The bend angle of the elbow 441 is chosen so that, when an over or under pressure is introduced, the line of action 450 (shown as a dash-and-dot line in FIG. 22) of the resultant force P₁ indicated by the double arrow 440, intersects the pivot 414. Thus the torque arm a drawn in FIG. 21 becomes zero, and according to formula (2) above the disruptive force P₂ also disappears, so that weighing can take place unimpeded.

FIG. 23 shows an embodiment which differs from FIG. 22 in that the filling pipe 411 is longer, is bent twice at right angles and is taken above the machine housing 402, on which it is supported by a post 442. The end of the filling pipe 411 bent perpendicularly upwards, which is again connected to the pipe 410 by the flexible piece of pipe 430, is located so that its axis intersects the pivot 414 as indicated by a dash-and-dot line. Thus if a force P₁, directed upwardly or downwardly in the direction of the double arrow 440, arises at the end of the filling pipe 411 joined to the piece of pipe 430 when above-atmospheric or low pressure is introduced, then its line of action 450 again runs through the pivot 414 and no disruptive force P₂ is exerted, for the reasons given in connection with FIG. 22.

1. A clothless invertible filter centrifuge for separating a suspension into a filtrate and solids, the filter centrifuge comprising
a centrifugal drum rotatably mounted in a drum housing and having a drum wall comprising a stationary, dimensionally stable filtering medium, the drum further comprising an edge with an open end, a closed end wall, and an interior;
a shaft driving the drum for rotation thereof;
a lid hermetically sealing the open end of the drum at the edge thereof;
a filling pipe leading into the interior of the drum, said filling pipe being disposed to feed the suspension into the interior of the drum;
a drum base disposed in the interior of the drum, which drum base and the filtering medium are axially displaceable relatively to each other from a withdrawn position in order to mechanically discharge at least a portion of the solids retained by the filtering medium out of the drum, the drum base having a peripheral surface and a sealing member at said peripheral surface, which member bears sealingly against the wall of the drum adjacent the closed end wall of the drum when the drum base is in said withdrawn position;
and a pneumatic contrivance for detaching and discharging residue remaining of the solids.

2. The centrifuge as defined in claim 1, wherein the drum has an inside diameter at its closed end wall, and the drum base has a diameter only slightly smaller than the inside diameter of the drum at its closed end wall.

3. The centrifuge as defined in claim 1, wherein the filtering medium is self-supporting.

4. The centrifuge as defined in claim 1, wherein the filtering medium is made of metal, ceramics, plastics or a mixture of these materials.

5. The centrifuge as defined in claim 1, wherein the pneumatic contrivance produces a gas stream in an axial direction of the drum.

6. The centrifuge as defined in claim 1, wherein the pneumatic contrivance produces a gas stream in a radial direction of the drum.

7. The centrifuge as defined in claim 1, wherein operation of the pneumatic contrivance can be synchronized with the relative movement of the drum base and drum wall.

8. The centrifuge as defined in claim 7, wherein the pneumatic contrivance and the drum wall are movable relative to each other in an axial direction of the drum.

9. The centrifuge as defined in claim 1, wherein the pneumatic contrivance produces a pulsating stream of gas.

10. The centrifuge as defined in claim 1, wherein the drum rotates at a first speed of rotation, and the pneumatic contrivance comprises nozzle-type outlets for providing a stream of gas, said nozzle-type outlets capable of being driven for rotation thereof at a different speed of rotation from said first speed.

11. The centrifuge as defined in claim 1, wherein the pneumatic contrivance comprises nozzle-type outlets disposed in the interior of the drum.

12. The centrifuge as defined in claim 11, wherein at least some of the nozzle-type outlets of the pneumatic contrivance disposed in the interior of the drum are located in the drum base.

13. The centrifuge as defined in claim 1, wherein outlets are provided in the interior of the drum for rinsing the drum wall with a liquid cleaning agent.

14. The centrifuge as defined in claim 1, wherein the lid is rigidly connected to the drum base via spacers.

15. The centrifuge as defined in claim 1, wherein the drum housing widens conically in a direction extending from the open end of the drum toward the closed end wall thereof.

16. The centrifuge as defined in claim 1, wherein the drum wall has a slightly conical shape and widens toward its open end.

17. The centrifuge as defined in claim 1, wherein the lid has an opening for accommodation of the filling pipe, the filling pipe having an outlet end located inside the drum during centrifugation.

18. The centrifuge as defined in claim 17, wherein the filling pipe can be connected to at least one of a pressure source and vacuum source to vary a pressure within the drum, the filling pipe being maintained in sealed relationship with the lid by means of a combined rotary/gliding seal, the rotary seal sealing the filling pipe relative to the lid as the lid rotates and the gliding seal sealing the pipe relative to the lid when the lid is displaced axially.

19. The centrifuge as defined in claim 18, wherein the filling pipe is supported on the housing in a resilient mounting which allows for tumbling motion of the filling pipe in conjunction with the rotary/gliding seal.

20. The centrifuge as defined in claim 17, wherein the filling pipe is held in the opening of the lid by a rotary/gliding seal which comprises a sleeve which is equipped with at least one of sealing rings and wiping rings and is rotatably mounted in a bush fixed to the lid.

21. The centrifuge as defined in claim 20, wherein the filling pipe has a thickened region at its outlet end which tapers off on both sides.

22. The centrifuge as defined in claim 17, wherein the opening in the lid can be hermetically sealed by a sealing element which rotates together with the drum and does not engage the filling pipe.

23. The centrifuge as defined in claim 22, wherein the drum can be connected to at least one of a pressure source and a vacuum source by a pipe leading from the end of the drum remote from the filling pipe.

24. The centrifuge as defined in claim 22, wherein the drum is mounted on a hollow shaft and the sealing element is displaceably mounted in said shaft such that the sealing element forms a tight seal between the opening and the interior of the drum.

25. The centrifuge as defined in claim 17, wherein the filling pipe is rotatably mounted about its longitudinal axis and can be set in rotation about said axis together with the drum.

26. The centrifuge as defined in claim 25, wherein the filling pipe can be rotated substantially synchronously with the drum by a drive means.

27. The centrifuge as defined in claim 25, further comprising a sealing element capable of being selectively moved to an open or closed position, the sealing element being arranged so as to provide a seal between the opening in the lid and the filling pipe.

28. The centrifuge as defined in claim 1, wherein the drum and the lid are axially displaceable relatively to each other by means of a rotated hollow shaft and a supporting shaft capable of being reciprocated therein, in order to displace the drum base to mechanically discharge at least a portion of the solids retained by the filtering medium out of the drum.

29. The centrifuge as defined in claim 28, further comprising a screw spindle disposed on the supporting shaft and a nut engaging said screw spindle, either the screw spindle or the nut being rotatable by a motor such that the supporting shaft telescopes to and fro in the hollow shaft depending on a rotational speed of the screw spindle or nut relative to a rotational speed of the hollow shaft.

30. The centrifuge as defined in claim 1, further comprising a safety device which prevents opening of the drum due to removal of the lid therefrom as long as the drum rotates at a rotational speed higher than a critical limit above which opening of the drum would be hazardous, the drum and lid being axially displaceable relatively to each other by means of a rotated hollow shaft or a supporting shaft telescoping to and fro therein, in order to mechanically discharge at least a portion of the solids retained by the filtering medium out of the drum by means of the drum base.

31. The centrifuge as defined in claim 30, further comprising a screw spindle disposed on the supporting shaft and a nut engaging the screw spindle, at least one of the screw spindle or the nut being rotatable by a motor such that the supporting shaft telescopes to and fro in the hollow shaft depending on a rotational speed of the screw spindle or nut relative to the rotational speed of the hollow shaft and drum, the drum lid opening when the rotational speed of the screw spindle or nut driven by the motor is higher than the rotational speed of the hollow shaft and closes when the rotational speed of the screw spindle or nut is lower than the rotational speed of the hollow shaft, a maximum speed of the motor is such that the maximum speed imparted by said motor to the screw spindle or nut is lower than the critical speed of the drum, so that the drum opens only when the drum rotates at a speed lower than the critical speed.

32. The centrifuge as defined in claim 31, wherein the screw spindle or nut can be driven at different speeds by a plurality of motors which can be switched on selectively, and the maximum speeds of said plurality of motors being such that the maximum speeds imparted by said plurality of motors to the screw spindle or nut are lower than the critical speed of the drum.

33. The centrifuge as defined in claim 1, wherein a flexible and/or expandable partition wall is disposed between the closed end wall of the centrifugal drum and the drum base movable relatively thereto, and the drum base being carried on a sliding shaft, said partition wall forming a seal between the sliding shaft carrying the drum base and the interior of the centrifugal drum receiving the suspension.

34. The centrifuge as defined in claim 33, wherein the partition wall is in the form of bellows which surrounds the sliding shaft ring and is fixed to the closed end wall at one end and to the drum base at the other.

35. The centrifuge as defined in claim 33, further comprising means for monitoring a differential pressure of pressures prevailing on opposite sides of the partition wall.

36. The centrifuge as defined in claim 1, further comprising a device for performing weighing measurements in a weighing process, the centrifuge being mounted for tilting in a vertical plane, a force-measuring member sensing weight-dependent tilting movements of the centrifuge, and compensating means balancing out disruptive forces caused by fluctuating gas pressures such that the weighing process is not affected thereby, the compensating means further comprising a sensor for sensing the gas pressure in the centrifuge, said sensor generating a correcting signal for the weighing readings in accordance with sensed changes in the gas pressure.

37. The centrifuge as defined in claim 36, wherein said centrifuge can be turned about a horizontal axis of rotation.

38. The centrifuge as defined in claim 1, further comprising a centrifuge housing comprising a first chamber having an outlet for discharging a filtrate and a second chamber having an outlet for mechanically discharging at least a portion of the solids retained by the filtering medium, the first chamber being sealingly enclosed by a first self-contained housing section and the second chamber being sealingly enclosed by a second self-contained housing section, the two housing sections further each being mounted for turning in different directions about separate axes so that said housing sections can be turned separately between a closed state and an open state relative to the centrifugal drum.

39. The centrifuge as defined in claim 38, wherein the two housing sections can be turned about vertical axes.

40. The centrifuge as defined in claim 38, wherein the first housing section has a general annular shape and the second housing section has a general cup shape having a substantially closed end wall, and that when the second housing section is closed it bears closely against the first housing section by means of an edge remote from the end wall.

41. The centrifuge as defined in claim 1, wherein there is an annular gap between the drum housing and the centrifugal drum at the edge of the drum in the region of a filtrate housing section and a solids housing section, the centrifuge further comprising protective means for producing a stream of a gaseous blocking medium in the annular gap surrounding the edge of the drum, the blocking medium preventing transfer of gaseous, liquid and/or solid substances between the filtrate housing section and the solids housing section.

42. The centrifuge as defined in claim 41, wherein two streams of the gaseous blocking medium can be produced in the annular gap, of which one said gaseous blocking medium is directed into the filtrate housing section and the other said gaseous blocking medium is directed into the solids housing section.

43. The centrifuge as defined in claim 41, further comprising a gas-shuttle pipe having a shut-off valve disposed between the filtrate housing section and the solids housing section.

44. The centrifuge as defined in claim 1, further comprising a downstream solids dryer, dehumidification and drying of solids taking place in the centrifugal drum by centrifuging, compression with pressurized gas and heat convection induced by a stream of drying gas, and in the solids dryer by heat convection induced by a stream of drying gas.

45. The centrifuge as defined in claim 44, wherein the invertible filter centrifuge and solids dryer are joined to form a unit by sealing means causing the centrifuge and dryer to be sealingly separated from each other, sensors being arranged on the inverted filter centrifuge and solids dryer to measure and provide readings of the extent to which dehumidification and drying has taken place therein and other operating characteristics associated therewith, joint control means which can be actuated in accordance with the readings provided by the sensors and, depending on these, adjust operating data, the control means automatically adjusting said operating data whereby operating times for dehumidification and drying in the centrifuge and in the solids dryer are co-ordinated, and mechanical centrifuging energy and thermal energy in the centrifuge and the dryer being simultaneously allotted so as to give an economic optimum.

46. The centrifuge as defined in claim 1, wherein the centrifuge further comprises a centrifuge housing and a device for undertaking weighing measurements, the centrifuge housing being mounted for turning about a swivel axis, and the device for undertaking weighing measurements comprising a measurement display, a force-measuring member adapted to sense weight-dependent deflections of the centrifuge housing about said swivel axis, said deflections being caused by at least one of different degrees of filling of the drum with suspension or different degrees of dehumidification of the solids of the suspension, the deflections being indicated on the measurement display, a pipe being provided to produce superatmospheric pressure or subatmospheric pressure in the drum, and the line of action of force generated in said pipe due to said super- or sub-atmospheric pressure being directed so that said line of action intersects the axis of rotation of the centrifuge housing.

47. The centrifuge as defined in claim 1, further comprising a centrifuge housing adapted to be turned about a swivel axis, and a force-measuring member capable of sensing weight-dependent deflections of the centrifuge housing about said swivel axis, as caused by at least one of different degrees of filling of the drum with suspension and different degrees of dehumidification of the solids of the suspension, a reading of the deflections being indicated on a measurement display, and a pipe being provided to produce a superatmospheric or subatmospheric pressure in the drum, and a sensor for sensing the pressure in the drum, said sensor producing a correcting signal by means of which the reading can be corrected in accordance with the pressure.

48. A method of separating a suspension into a filtrate and solids using a clothless invertible filter centrifuge according to claim 1, wherein the suspension is conveyed through the filling pipe into the interior of the drum, the filtrate passing through the filtering medium by virtue of centrifugal forces prevailing when the drum rotates, the solids component being retained by the filtering medium on the drum wall, and wherein, mechanically discharging of the solids using the drum base, pneumatically removing residues of the solids left on the filtering medium by means of streams of gas acting in at least one of a radial and axial direction.

49. The method as defined in claim 48, wherein, prior to the mechanically discharging step, causing streams of gas to flow through the filtering medium toward the interior of the drum in order to loosen the solids.

50. The method as defined in claim 49, wherein the causing the streams of gas step comprises creating a subatmospheric pressure in the interior of the drum.

51. The method as defined in claim 49, wherein the causing the streams of gas step comprises generating at least one pressure or vacuum pulses.

52. The method as defined in claims 48, wherein said streams of gas acting in said radial direction are produced while the drum base is moved from a starting position to an ejecting position adjacent the open end of the drum.

53. The method as defined in claim 52, wherein the streams of gas acting in said radial direction are produced progressively from a position adjacent the starting position of the drum base toward said ejecting position, synchronously with the movement of the drum base.

54. The method as defined in claim 52, wherein steady streams of gas acting in said radial direction are produced when the drum rotates.

55. The method as defined in claim 52, wherein streams of gas acting in said axial direction are superimposed on the streams of gas acting in said radial direction.

56. The method as defined in claim 48, wherein the streams of gas acting in said axial direction are produced synchronously with the movement of the drum base from a starting position to an ejecting position and travelling with it.
